(19) United States
(12) Patent Application Publication
(10) Pub. No.: US 2020/0363681 A1
(43) Pub. Date: Nov. 19, 2020

(54) METHOD, SYSTEM AND APPARATUS FOR REFLECTIVE-EMISSIVE HYBRID DISPLAY

(71) Applicant: Concord (HK) International Education Limited, Wan Chai (CN)

(72) Inventors: Lorne A. Whitehead, Vancouver (CA); Robert J. Fleming, San Jose, CA (US)

(21) Appl. No.: 16/864,985

(22) Filed: May 1, 2020

Related U.S. Application Data
(63) Continuation of application No. PCT/US2018/059216, filed on Nov. 5, 2018.
(60) Provisional application No. 62/581,205, filed on Nov. 3, 2017.

(51) Int. Cl. G02F 1/1335; F21V 8/00; G02F 1/13357

(52) U.S. Cl. CPC G02F 1/133528; G02F 1/133514; G02F 1/133553; G02F 2001/133616; G02B 6/0055; G02F 1/13362; G02B 6/0056

(57) ABSTRACT

Conventional reflective liquid crystal displays (LCDs) suffer from low brightness and exhibit a metallic gray-like appearance. Conventional emissive LCDs are difficult to view in high brightness conditions and use substantial amounts of power due to the backlight. The disclosed embodiments relate to a novel reflective-emissive hybrid display comprising a liquid crystal layer combined with a total internal reflection (TIR) based high gain reflector. The high gain reflector may include a semi-retro-reflective sheet comprising of convex protrusions that reflects light that substantially retains the polarization of the incident light. The display further comprises spectrally notched absorbing color filters and narrow band light emitting sources. In certain embodiments, the spectrally notching absorbing color filter may be matched to the narrow band light emitting source. The display embodiments described herein illustrates a hybrid display and may efficiently operate in low lighting and high brightness conditions using front or back lighting systems. The display embodiments described herein may also be used in other reflective display technologies such as microencapsulated electrophoretic displays and electrowetting displays.

### CROSS-REFERENCE TO RELATED APPLICATIONS

The present application is a continuation of International Patent Application No. PCT/US18/59216, filed Nov. 5, 2018, which claims the benefit of U.S. Provisional Application No. 62/581,205, filed Nov. 3, 2017, both of which are incorporated herein by reference in their entireties for all purposes.

### FIELD

The disclosed embodiments generally relate to reflective and emissive image displays. In one embodiment, the disclosure relates to a total internal reflection-based high gain reflector. In another embodiment, the disclosure relates to a hybrid display with a spectrally notched color filter, narrow band emissive LEDs and total internal reflection-based high gain reflector capable of efficiently operating in low lighting and high brightness conditions.

### BACKGROUND

Liquid crystal displays (LCDs) are one of the most common display technologies on the market. LCDs use a thin layer of liquid crystal material to control the emission or reflectance of a display. Liquid crystals (LCs) represent an unusual phase of matter since, unlike typical liquids with randomly oriented molecules, their molecules exhibit some degree of orientational alignment. Depending on the substance itself and the environmental conditions, a liquid crystal may take one of a number of phases. The phases include nematic, chiral nematic (substances forming this phase are often called cholesteric liquid crystals) and smectic liquid crystals. It is important to note that in all of these phases, an anisotropy results from the preferred orientation of the molecules, particularly in terms of the interaction of light with these materials.

In an image display device, a thin layer of liquid crystal material is typically contained in a gap between two glass plates. An electric field may be applied across the gap to cause the permanent or induced dipoles in the liquid crystal molecules to orient with the dipole axis parallel to the field.

Polarization is a characteristic of light that describes the direction of the electric and magnetic fields comprising the wave. For instance, linearly polarized light is a special case in which the electric field points in a single direction. The anisotropy of a liquid crystal resulting from the orientational alignment causes light that is linearly polarized parallel to a specified direction to propagate at a different velocity than light that is linearly polarized perpendicular to that specified direction. In view of this behavior, it is useful to consider that light is a combination of these two linear polarizations.

The two polarization components travel through a slab of liquid crystal material at two different velocities, and therefore may emerge from the material with a phase difference that is proportional to the thickness of the material. Thus, the orientational alignment of a liquid crystal affects the change it imparts to the polarization of incident light, which is why LCs are so useful in image displays.

Linearly polarized light can be produced by passing unpolarized light through a polarizing material that almost completely absorbs one polarization while allowing the other polarization to pass through fairly efficiently. If two such polarizing filters are layered with perpendicular polarization directions (in an arrangement known as crossed polarizers), very little light will pass through since the linearly polarized light emerging from the first polarizer will be absorbed by the second. The insertion of an isotropic material between the two polarizers will have no effect on the transmission of light since the polarization of the light is unchanged as it passes through such a material. A liquid crystal material inserted between the two polarizer filters, however, changes the polarization state such that some of the light will transmit through the stack. The application of an electric field across the liquid crystal can deform the crystal structure to change this anisotropy. In this manner, the amount of light that passed through the stack can be controlled.

Liquid crystals may be used in two primary types of image displays, namely transmissive and reflective. Transmissive displays may be constructed by stacking the appropriate polarizing filters and liquid crystal material to form a LC panel and incorporating a backlight to direct light through the liquid crystal panel toward the viewer. In the bright state, the molecules are oriented such that light passes through the panel. In the dark state, the light is absorbed, and the region looks dark. To generate each of these states, the anisotropy of the liquid crystal material is changed by the application of an electric field.

The reflective configuration is similar, but includes a polarization-preserving rear reflector instead of a backlight. In this case, the bright state again allows polarized incident light to pass fairly efficiently through the layers, where it reflects from the rear reflector, and passes again through the panel to return to the viewer. In the dark state, the light is absorbed, creating a dark appearance. These passive displays rely on the ambient lighting conditions, rather than a backlight, for the image on the display to be visible.

FIG. 1 schematically illustrates a cross-section of a portion of a conventional reflective LC display. Prior art conventional reflective display 100 in FIG. 1 comprises a protective transparent cover sheet 102, such as glass or a polymer, with outward surface 104 facing viewer 106. LC display 100 further comprises a front polarizing film 108 and transparent front electrode layer 110. Layer 110 typically comprises indium tin oxide (ITO). Prior art display 100 may further comprise a liquid crystal layer 112, rear common electrode layer 114 and rear glass support sheet 116. Layer 112 is typically filled with nematic-type liquid crystals. Electrode layers 110, 114 may be connected by a power source 118 such as a battery. Prior art display 100 may further comprise a second polarizing layer 120 placed at a right angle to front polarizing film 108 and a rear light reflecting sheet 122 such as a mirror. Display 100 may comprise one or more of addressable pixels or segments.

When there is no voltage applied to a pixel or segment of prior art display 100, light may completely pass through the display and be reflected by rear reflective layer 122 back towards viewer 106. The pixel or segment may appear in a light or bright state to viewer 106. When a voltage is applied to a pixel or segment forming an electric field across liquid crystal layer 112 to align the liquid crystals, light may be absorbed. The pixel or segment may appear dark to viewer 106.

A full-color image may also be generated in both the reflective and transmissive display configurations using a color filter overlay. Transmissive liquid crystal displays yield bright, colorful images by illuminating the display with a high intensity backlight. The backlight system may comprise a light source, such as light emitting diodes (LEDs), and a light guide. This is a visually effective technique, but because of the substantial power consumption of the backlight, it is inappropriate for low power, battery-operated device applications. Reflective displays, on the other hand, can operate on low power since they reflect the ambient light, but the maximum reflectance of such displays is quite limited. In theory, a monochrome LC display may be at most 50% reflective since at least half of the ambient light must be absorbed by the polarizer. In practice, the maximum reflectance of a typical monochrome reflective display is about 34%, and this value drops to at most about 16% for a full-color reflective liquid crystal display. A powerful front-light is sometimes used to illuminate this display surface for improved legibility, but again this drastically increases the power required to operate the device. Reflective LCDs also typically exhibit an unappealing gray or metallic-like appearance due to the specular-like rear reflector required to maximize the brightness of the display.

### BRIEF DESCRIPTION OF DRAWINGS

These and other embodiments of the disclosure will be discussed with reference to the following exemplary and non-limiting illustrations, in which like elements are numbered similarly, and where:

FIG. 1 schematically illustrates a cross-section of a portion of a conventional reflective LCD;

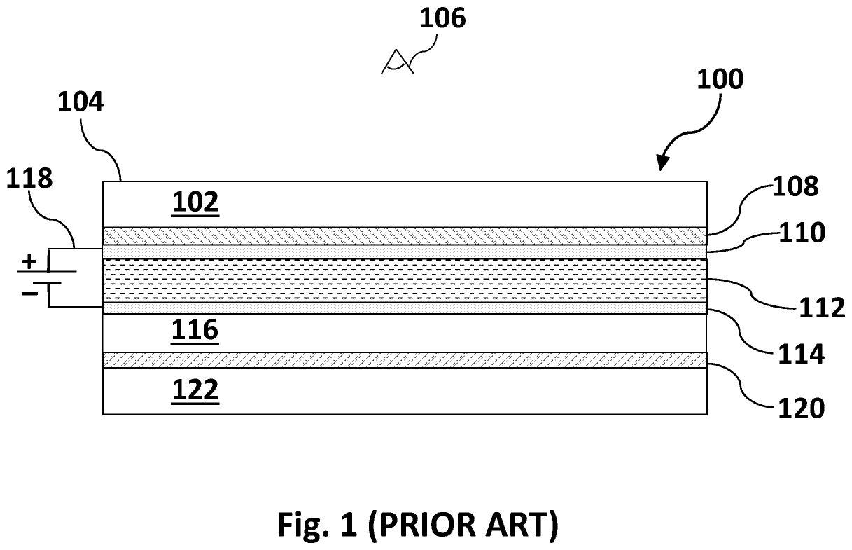

FIG. 2A schematically illustrates a cross-section of an embodiment of a hybrid reflective-emissive LC-high gain reflector display in a bright state in the reflective mode of operation;

FIG. 2B schematically illustrates a cross-section of an embodiment of a hybrid reflective-emissive LC-high gain reflector display in a dark state in the reflective mode of operation;

FIG. 2C schematically illustrates a cross-section of an embodiment of a hybrid reflective-emissive LC-high gain reflector display in a bright state in the emissive mode of operation;

FIG. 2D schematically illustrates a cross-section of an embodiment of a hybrid reflective-emissive LC-high gain reflector display in a dark state in the emissive mode of operation;

FIG. 3A graphically illustrates the spectral transmission of an embodiment of a red filter region in a spectrally notched absorbing color filter array;

FIG. 3B graphically illustrates the spectral transmission of an embodiment of a green filter region in a spectrally notched absorbing color filter array;

FIG. 3C graphically illustrates the spectral transmission of an embodiment of a blue filter region in a spectrally notched absorbing color filter array;

FIG. 4A graphically illustrates the spectral transmission of an embodiment of a red filter region in a spectrally notched absorbing color filter array comprising of four absorptions;

FIG. 4B graphically illustrates the spectral transmission of an embodiment of a green filter region in a spectrally notched absorbing color filter array comprising of four absorptions;

FIG. 4C graphically illustrates the spectral transmission of an embodiment of a blue filter region in a spectrally notched absorbing color filter array comprising of four absorptions;

FIG. 5A graphically illustrates the spectral transmission of an embodiment of a red filter region in a spectrally notched absorbing color filter array and a red narrow wavelength emission from the waveguide;

FIG. 5B graphically illustrates the spectral transmission of an embodiment of a green filter region in a spectrally notched absorbing color filter array and a green narrow wavelength emission from the waveguide;

FIG. 5C graphically illustrates the spectral transmission of an embodiment of a blue filter region in a spectrally notched absorbing color filter array and a blue narrow wavelength emission from the waveguide;

FIG. 6A graphically illustrates the spectral transmission of an embodiment of a red filter region in a spectrally notched absorbing color filter array comprising of four absorption and two emission bands from the waveguide;

FIG. 6B graphically illustrates the spectral transmission of an embodiment of a green filter region in a spectrally notched absorbing color filter array comprising of four absorption and two emission bands from the waveguide;

FIG. 6C graphically illustrates the spectral transmission of an embodiment of a blue filter region in a spectrally notched absorbing color filter array comprising of four absorption and two emission bands from the waveguide;

FIG. 7A schematically illustrates a cross-section of an embodiment of a hybrid reflective-emissive LC-high gain reflector display with a front light in a bright state in the reflective mode of operation;

FIG. 7B schematically illustrates a cross-section of an embodiment of a hybrid reflective-emissive LC-high gain reflector display with a front light in a dark state in the reflective mode of operation;

FIG. 7C schematically illustrates a cross-section of an embodiment of a hybrid reflective-emissive LC-high gain reflector display with a front light in a bright state in the emissive mode of operation;

FIG. 7D schematically illustrates a cross-section of an embodiment of a hybrid reflective-emissive LC-high gain reflector display with a front light in a dark state in the emissive mode of operation;

FIG. 8 schematically illustrates an embodiment of a TFT array to drive a display; and

FIG. 9 schematically illustrates an exemplary system for implementing an embodiment of the disclosure.

### DETAILED DESCRIPTION

Throughout the following description specific details are set forth in order to provide a more thorough understanding to persons skilled in the art. However, well-known elements may not have been shown or described in detail to avoid unnecessarily obscuring the disclosure. Accordingly, the description and drawings are to be regarded in an illustrative, rather than a restrictive or exclusive, sense.

This disclosure generally relates to reflective-emissive hybrid image displays.

Certain low power reflective display embodiments described herein combine a high gain reflector unit, an LCD layer, spectrally notched color filters and a narrow band light emission layer to create a hybrid reflective-emissive display. The hybrid reflective-emissive display invention described herein is capable of operating in reflective mode, emissive mode or a hybrid reflective/emissive mode from low lighting conditions to high brightness conditions. The combination of the design elements described herein may yield enhanced performance in both reflective and emissive modes of operation. In some embodiments described, the overall brightness of reflective LCDs is enhanced. In addition, the embodiments described herein may give a reflective LCD a whiter and more visually pleasing paper-like appearance than what is currently on the market.

According to certain embodiments of the disclosure, a hybrid reflective-emissive liquid crystal display comprises a transparent sheet further comprising at least one convex protrusion. In certain embodiments, a hybrid reflective-emissive liquid crystal display comprises a transparent sheet further comprising at least one convex protrusion and a spectrally notched absorbing color filter layer. In some embodiments, a hybrid reflective-emissive liquid crystal display comprises a transparent sheet further comprising at least one convex protrusion, a spectrally notched absorbing color filter layer and a spectrally notched transmitting specular reflector. In some embodiments, a hybrid reflective-emissive liquid crystal display comprises a transparent sheet further comprising at least one convex protrusion, a spectrally notched absorbing color filter layer, a spectrally notched transmitting specular reflector and a reflective polarizer layer. In some embodiments, a hybrid reflective-emissive liquid crystal display comprises a transparent sheet further comprising at least one convex protrusion, a spectrally notched absorbing color filter layer, a spectrally notched transmitting specular reflector and a backlight system. In some embodiments, a hybrid reflective-emissive liquid crystal display comprises a transparent sheet further comprising a spectrally notched absorbing color filter layer, a spectrally notched transmitting specular reflector and a front light system. In other embodiments, a hybrid reflective-emissive microencapsulated electrophoretic display comprises a spectrally notched absorbing color filter layer and a narrow band LED light source. In still other embodiments, a hybrid reflective-emissive electrowetting display comprises a spectrally notched absorbing color filter layer and a narrow band LED light source.

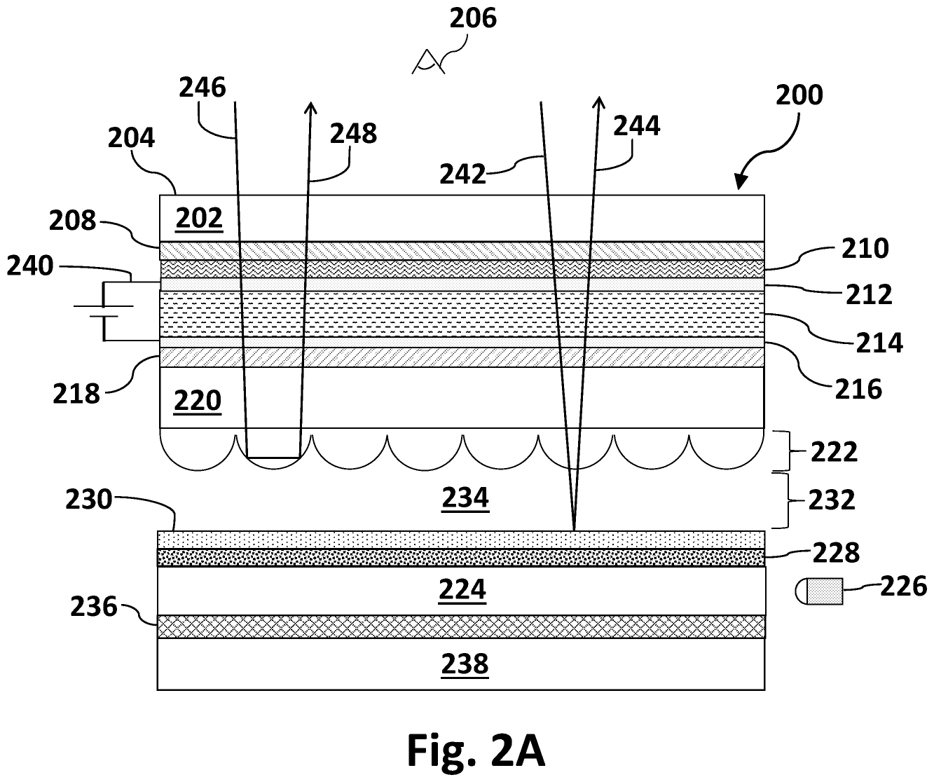

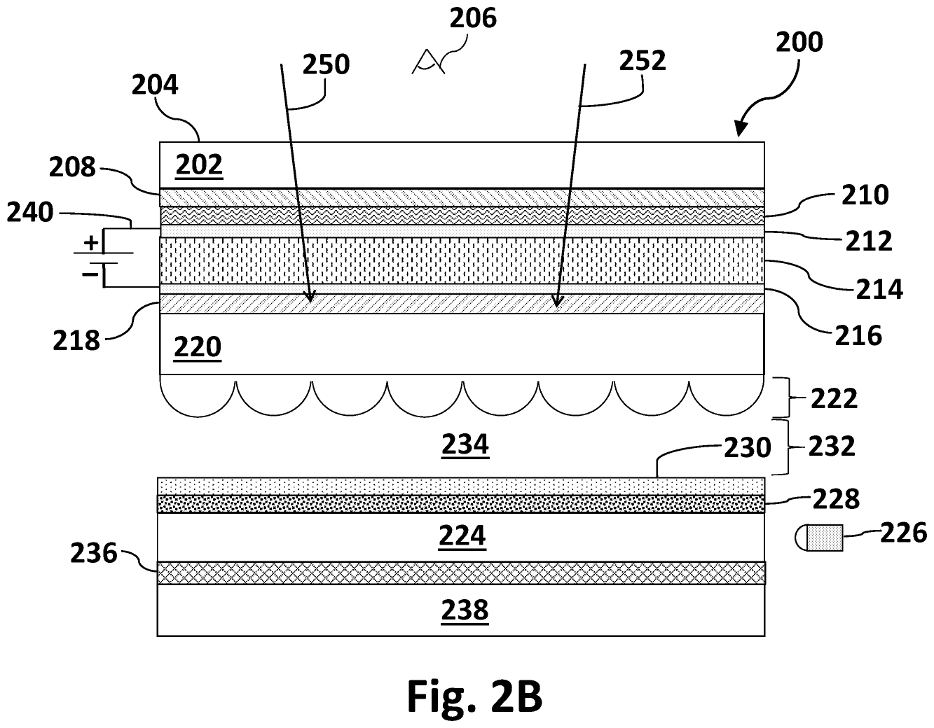

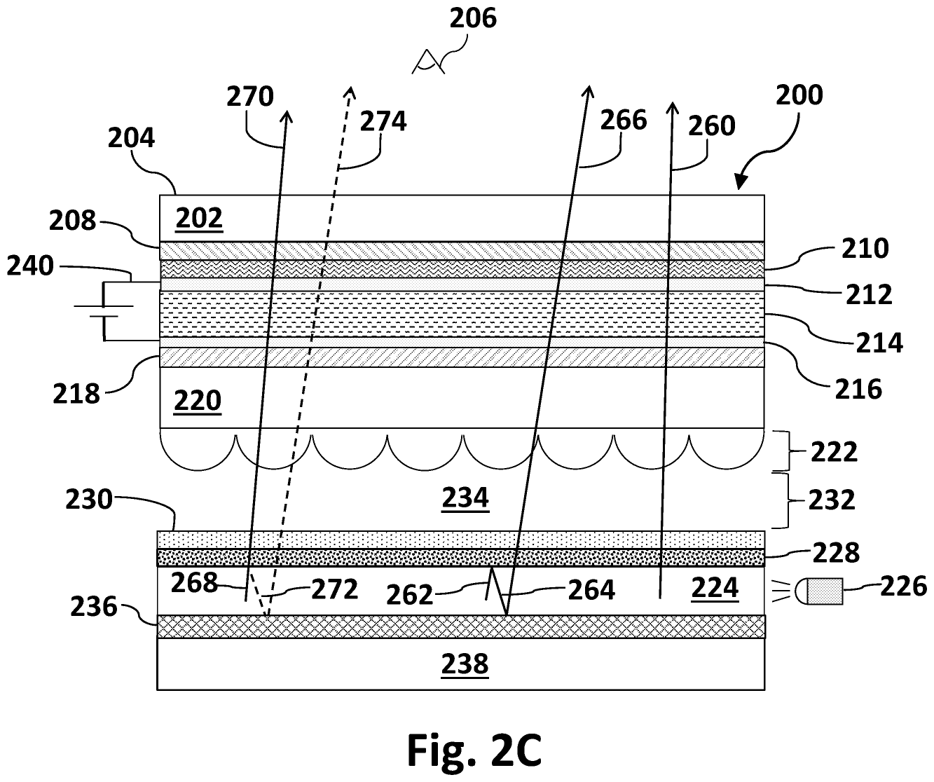

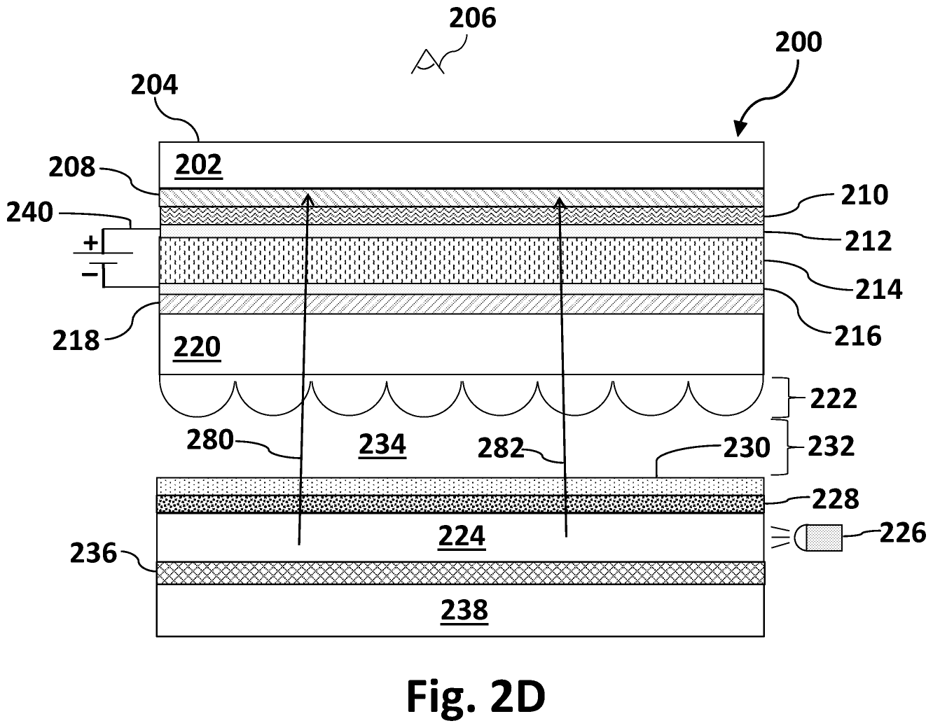

FIG. 2A schematically illustrates a cross-section of an embodiment of a hybrid reflective-emissive LC-high gain reflector display in a bright state. Display 200 may comprise an outer transparent sheet 202 with outer surface 204 facing viewer 206. In some embodiments, sheet 202 may be flexible or conformable (flexible may also be referred to as rollable or bendable with the ability to be bent without breaking). Sheet 202 may comprise glass. In some embodiments, sheet 202 may comprise glass of thickness in the range of about 20-2000 μm. In an exemplary embodiment, sheet 202 may comprise glass of thickness in the range of about 20-250 μm. Sheet 202 may comprise a flexible glass such as SCHOTT AF 32® eco or D 263 ® T eco ultra-thin glass. Sheet 202 may comprise a transparent polymer such as polycarbonate or an acrylic such as poly(methyl methacrylate).

In some embodiments, sheet 202 may also perform as a transparent barrier layer. A barrier layer may be located in various locations within the display embodiments described herein. Sheet 202 may act as one or more of a gas barrier or moisture barrier and may be hydrolytically stable. Sheet 202 may comprise one or more of polyester, polypropylene, polyethylene terephthalate, polyethylene naphthalate or copolymer, or polyethylene. Sheet 202 may comprise one or more of a chemical vapor deposited (CVD) or sputter coated ceramic-based thin film on a polymer substrate. The ceramic may comprise one or more of Al₂O₃, SiO₂ or other metal oxide. Sheet 202 may comprise one or more of a Vitriflex barrier film, Invista OXYCLEAR® barrier resin, Toppan GL′ barrier films GL-AEC-F, GX-P-F, GL-AR-DF, GL-ARH, GL-RD, Celplast Ceramis® CPT-036, CPT-001, CPT-022, CPA-001, CPA-002, CPP-004, CPP-005 silicon oxide (SiOₓ) barrier films, Celplast CAMCLEAR® aluminum oxide (AlOx) coated clear barrier films, Celplast CAMSHIELD® T AlOx-polyester film, Torayfan® CBH or Torayfan® CBLH biaxially-oriented clear barrier polypropylene films.

Display 200 in FIG. 2A may comprise a first light polarizer film 208. Polarizer film 208 may also be referred to as an optical filter. In an exemplary embodiment, film 208 is an absorptive polarizer. Film 208 may comprise a polymer. Film 208 may comprise a flexible polymer. Film 208 may comprise glass. Film 208 may comprise an aluminum film with fine slits on glass or polymer. Polarizer film 208 may filter or absorb perpendicular or parallel polarized light and allow linear polarized light to pass through. Polarizer film 208 may be located on the inner side of sheet 202 as illustrated in FIG. 2A. Polarizer film 208 may also be located on the outer side of sheet 202 facing viewer 206. Film 208 may comprise one or more of MOXTEK™ (Orem, Utah, USA) ProFlux® ABS series of polarizers such as ABB06C, ABB07C, ABB08C, ABG06C, ABG22C, ABG08C, ABR06C, ABR08C, ABR09C, Polaroid™ polarizing films (Minnetonka, Minn., USA) or Polarium™ (San Jose, Calif., USA) polarizing films.

Display embodiment 200 in FIG. 2A may comprise a color filter layer 210. Color filter layer 210 may be located anywhere within display 200. In an exemplary embodiment, layer 210 may comprise a spectrally notched absorbing color filter layer. Spectrally, notched color filter arrays comprise partially saturated (i.e., non-saturated) color filters. The partial saturation is due to the use of narrow, deep notches in the transmission as a function of wavelength.

While the specification refers to filters (e.g., optical, color, etc.) as general filters, it should be noted that optical filters may include bandpass filters which allow passage of particular wavelength (or group of wavelengths) while filtering out the non-matching bandwidths. In this manner, the light source and the filter may be substantially spectrally matched.

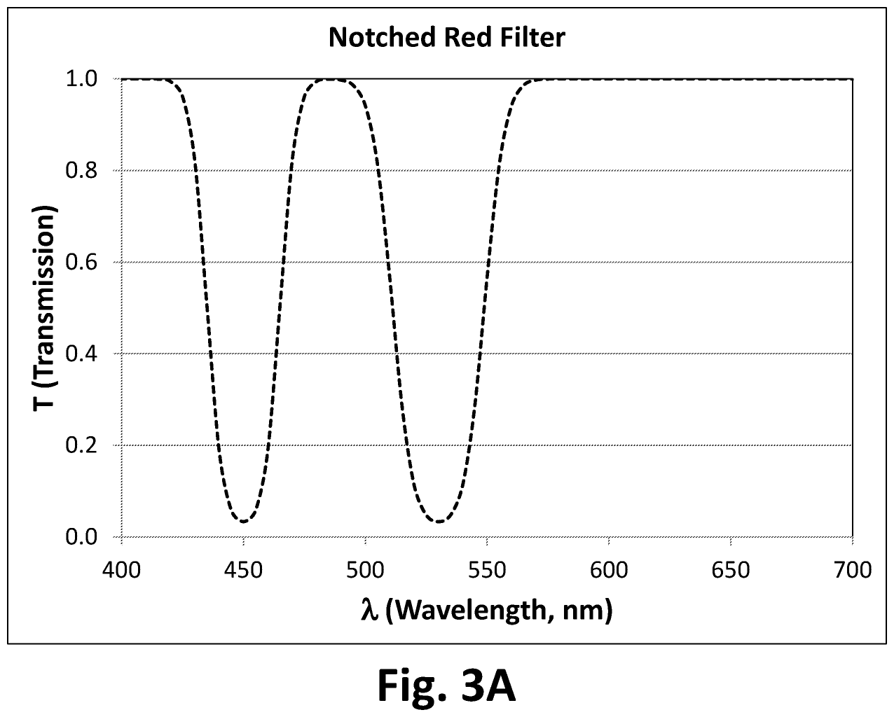

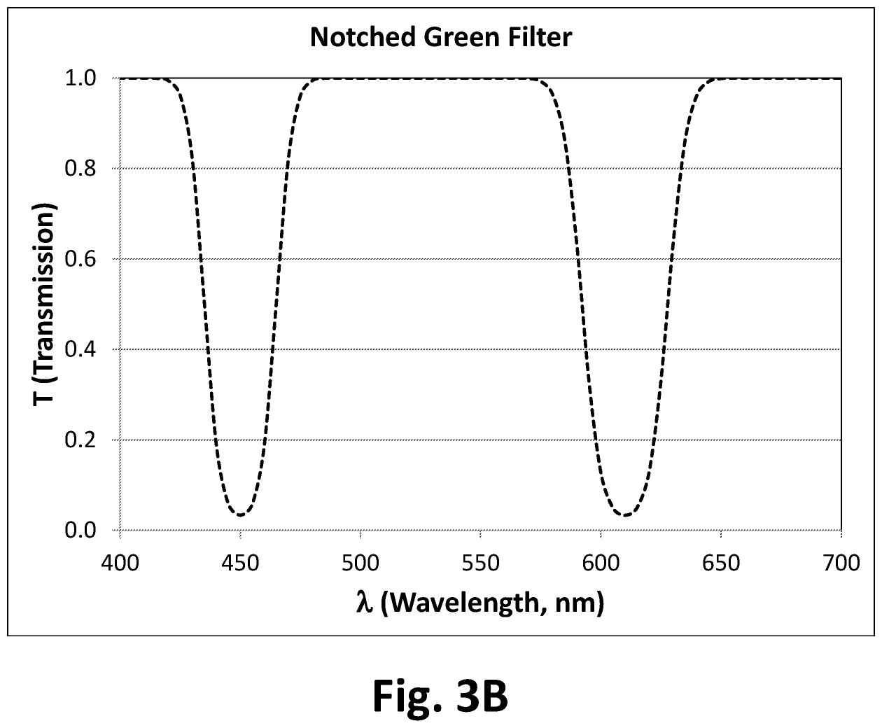

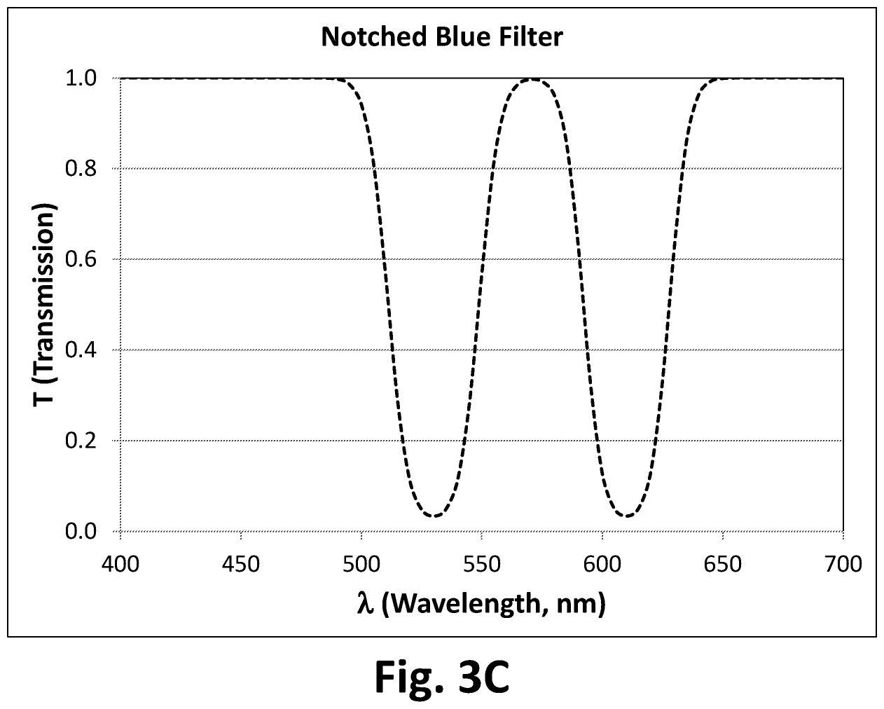

FIG. 3A graphically illustrates the spectral transmission of an embodiment of a red filter region in a spectrally notched absorbing color filter array. Deep notches in the transmission as a function of λ (wavelength, nm) are seen at about 450 nm and 530 nm in FIG. 3A. The notched wavelength bands correspond to absorptions in blue and green light regions. This is an illustrative example only as other bands centered at other wavelengths may be used.

FIG. 3B graphically illustrates the spectral transmission of an embodiment of a green filter region in a spectrally notched absorbing color filter array. Deep notches in the transmission as a function of λ (wavelength, nm) are seen at about 450 nm and 530 nm in FIG. 3B. The notches correspond to absorptions in blue and red light regions.

FIG. 3C graphically illustrates the spectral transmission of an embodiment of a blue filter region in a spectrally notched absorbing color filter array. Deep notches in the transmission as a function of λ (wavelength, nm) are seen at about 530 nm and 610 nm in FIG. 3C. The notches correspond to absorptions in green and red light regions.

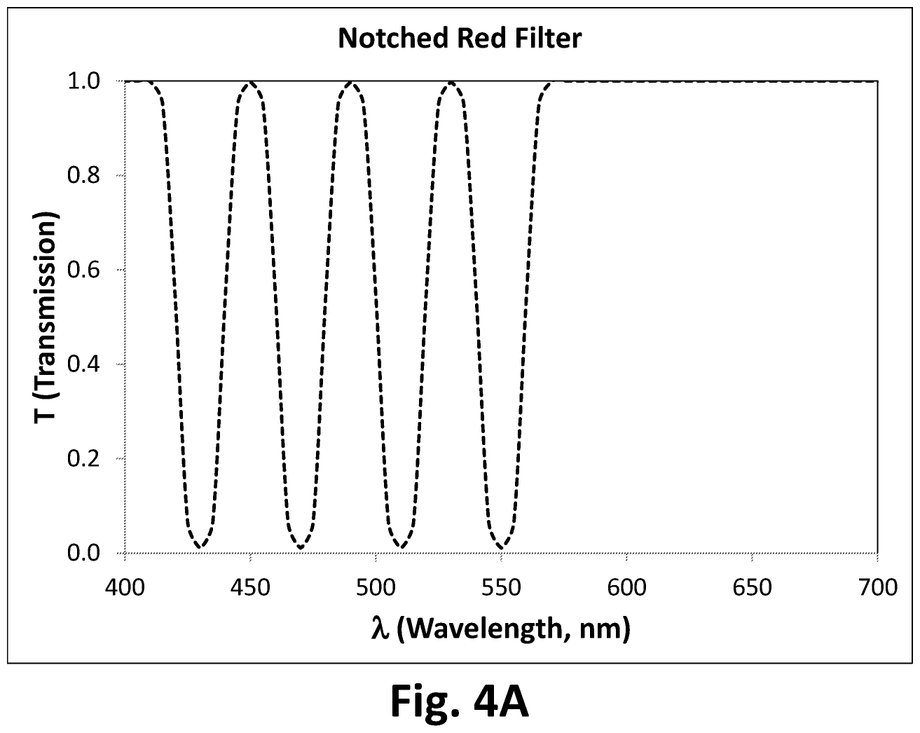

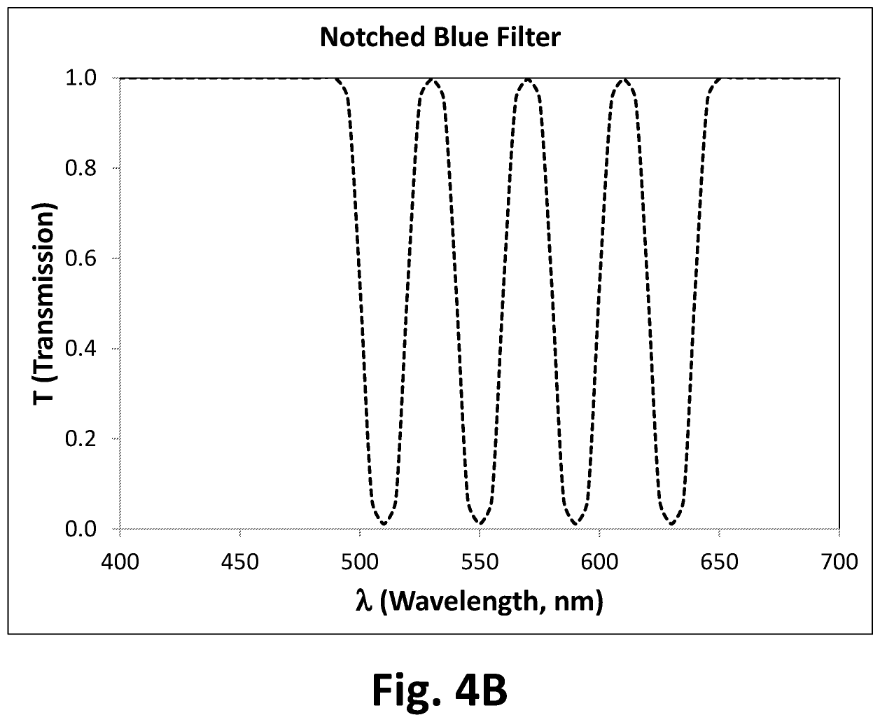

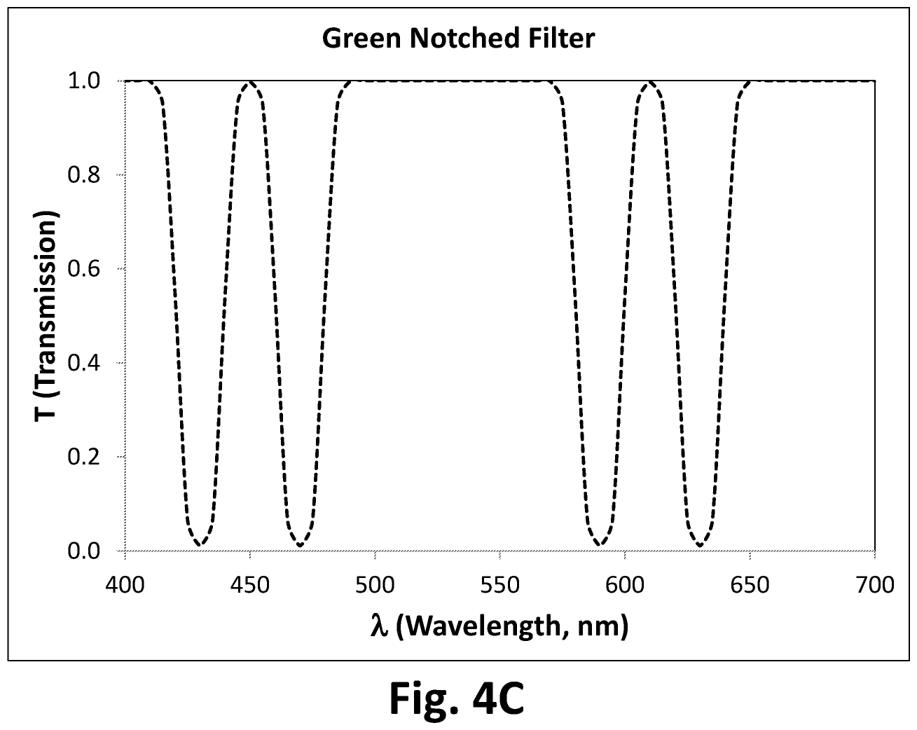

Spectrally notched filters (interchangeably, spectrally notched color filters) used in the display embodiments described herein may not be limited to two absorption bands as graphically illustrated in FIGS. 3A-C. FIG. 4A graphically illustrates the spectral transmission of an embodiment of a red filter region in a spectrally notched absorbing color filter array comprising of four absorptions. Deep notches in the transmission as a function of λ (wavelength, nm) are seen at about 430 nm, 470 nm, 510 nm and 550 nm in FIG. 4A. The notched wavelength bands correspond to absorptions in blue and green light regions. The widths of the notched wavelength bands may vary within the same color region or may vary in different color regions.

FIG. 4B graphically illustrates the spectral transmission of an embodiment of a green filter region in a spectrally notched absorbing color filter array comprising of four absorptions. Deep notches in the transmission as a function of λ (wavelength, nm) are seen at about 510 nm, 550 nm, 580 nm and 630 nm in FIG. 4B. The notched wavelength bands correspond to absorptions in blue and red light regions.

FIG. 4C graphically illustrates the spectral transmission of an embodiment of a blue filter region in a spectrally notched absorbing color filter array comprising of four absorptions. Deep notches in the transmission as a function of λ (wavelength, nm) are seen at about 430 nm, 470 nm, 580 nm and 630 nm in FIG. 4C. The notched wavelength bands correspond to absorptions in green and red light regions.

A spectrally notched absorbing filter array yields a similar result as conventional broader-band non-saturated filter arrays used in reflective color LCDs. This is because only a portion of the light in the absorption range may be absorbed. Conventional broader-band, non-saturated, filter arrays have moderate absorption over a wide wavelength band, whereas in spectrally notched absorbing filters, there is high absorption but only in narrow regions within the desired band.

The notched filters may absorb in one or more regions. FIGS. 3A-C illustrate absorption in two narrow regions while FIGS. 4A-C illustrate absorption in four narrow regions. Using the red filter as an example, light within a narrow blue peak and a narrow green peak is almost completely absorbed as illustrated in FIG. 3A, but light at other wavelengths in the blue and green regions undergoes little absorption. The result may be a pale or pastel red, rather than a deep red. In the reflective mode of operation of the hybrid display embodiments described herein, notched color filter arrays may not have a particular performance advantage over a standard absorbing CFA, but nor is there any performance disadvantage. Both types of color filter arrays may yield a similar non-saturated color image. However, according to the disclosed embodiments, notched filters have a significant advantage when combined with a backlight or front light, as will be described later in this disclosure. In certain embodiments, the backlight may be matched to the notched filter.

Referring again to FIG. 2A, embodiment 200 includes a top electrode layer 212. In an exemplary embodiment, layer 212 is substantially transparent. In an exemplary embodiment, layer 212 may comprise an active matrix thin film transistor array typically used in LCDs. Layer 212 may comprise indium tin oxide (ITO), aluminum, copper, gold, Baytron™, or conductive nanoparticles, silver wires, metal nanowires, graphene, nanotubes, or other conductive carbon allotropes or a combination of these materials dispersed in a polymer. Layer 212 may comprise a segmented or patterned array of electrodes. Layer 212 may comprise a direct drive or passive matrix arrays of electrodes. Layer 212 may be comprised of an array of pixels that may be used to drive display embodiment 200. In some embodiments, layer 212 may act as a common electrode. Front electrode layer 212 may comprise a transparent conductive material further comprising silver nano-wires manufactured by C3Nano (Hayward, Calif., USA). Front electrode layer 212 may comprise C3Nano ActiveGrid™ conductive ink.

Display embodiment 200 in FIG. 2A may comprise a liquid crystal layer 214. In an exemplary embodiment, layer 214 comprises twisted nematic liquid crystals. In other embodiments, layer 214 may comprise nematic, chiral nematic (substances forming this phase are often called cholesteric liquid crystals) and smectic liquid crystals. In some embodiments, the thickness of layer 214 may be in the range about 1-50 μm. In other embodiments the thickness of layer 214 may be in the range of about 5-25 μm. In an exemplary embodiment, layer 214 may comprise beads or fibers to maintain a substantially uniform thickness of layer 214. In other embodiments, layer 214 may comprise spacers to maintain a substantially uniform thickness. The fibers, beads and spacers may be comprised of glass or polymer. In an exemplary embodiment, layer 214 may comprise a sealant to prevent loss of the liquid crystals (LCs) or to prevent moisture or gas ingress. The LC layer 214 may comprise polymer walls. In an exemplary embodiment, polymer walls in LC layer 214 may be formed by processes and methods described in U.S. Pat. No. 5,668,651 (Sharp Kabushiki Kaisha, Osaka, Japan) and PCT Publ. Nos. WO 2016/206771 A1, WO 2016/206772 A1 and WO 2016/206774 A1 (Merck Patent GMBH, Darmstadt, Germany). In one embodiment, LC layer 214 may span and be shared by more than one pixel or sub-pixels in display 200. That is, a plurality of pixels may use the same LC. This embodiment makes control of the LC simpler in that several pixels use the same LC simultaneously. In alternative embodiment, display 200 may be configured such that each pixel (or sub-pixel) uses a dedicated LC. In this manner, while circuit complexity may increase, a more precise control of each pixel may be implemented.

Display embodiment 200 of FIG. 2A also includes a rear electrode layer 216. Rear electrode layer 216 may reside on the opposite side of the liquid crystal layer 214 from the front electrode layer 212. In an exemplary embodiment, layer 216 may be substantially transparent. In an exemplary embodiment, layer 216 may comprise an active matrix thin film transistor array typically used in LCDs. Layer 216 may comprise indium tin oxide (ITO), aluminum, copper, gold, Baytron™, or conductive nanoparticles, silver wires, metal nanowires, graphene, nanotubes, or other conductive carbon allotropes or a combination of these materials dispersed in a polymer. Layer 216 may comprise a segmented or patterned array of electrodes. Layer 216 may comprise a direct drive or passive matrix arrays of electrodes. Layer 216 may be comprised of an array of pixels that may be used to drive display embodiment 200. In some embodiments, layer 216 may act as a common electrode. Rear electrode layer 216 may comprise a transparent conductive material further comprising silver nano-wires manufactured by C3Nano (Hayward, Calif., USA). Rear electrode layer 214 may comprise C3Nano ActiveGrid™ conductive ink. Layers 212 and 216 may be used to apply a voltage bias to layer 214 to be able to change the orientation of the liquid crystals.

Display embodiment 200 in FIG. 2A may comprise a second light polarizer film 218. Polarizer film 218 may also be referred to as an optical filter. In an exemplary embodiment, film 218 is an absorptive polarizer. Film 218 may comprise a polymer. Film 218 may comprise a flexible polymer. Film 218 may comprise glass. Film 218 may comprise an aluminum film with fine slits on glass or polymer. Polarizer film 218 may filter or absorb perpendicular or parallel polarized light. Film 218 may comprise one or more of MOXTEK™ (Orem, Utah, USA) ProFlux® ABS series of polarizers such as ABB06C, ABB07C, ABB08C, ABG06C, ABG22C, ABG08C, ABR06C, ABR08C, ABR09C, Polaroid™ polarizing films (Minnetonka, Minn., USA) or Polarium™ (San Jose, Calif., USA) polarizing films. In an exemplary embodiment, the polarization direction of film 218 is placed at a substantially 90° or right angle to the polarization direction of first polarizing film 208. In other embodiments, the polarization direction of film 218 may be placed at any angle in the range of about 0-90° with respect to the polarization direction of film 208. In an exemplary embodiment, films 208 and 218 may be comprised of substantially the same material.

In certain embodiments, the disclosed embodiments combine a high gain reflector unit with an LCD layer to increase the overall brightness of reflective LCDs. The high gain reflector unit may comprise a polarization retention, semi-retro-reflective layer. The high gain reflector unit may comprise a de-polarizing, semi-retro-reflective layer. Furthermore, the embodiments described herein may make reflective LC displays more amenable to addition of a color filter layer for full-color reflective LCDs that are brighter than what is currently on the market. In addition, the embodiments described herein may give a reflective LCD a whiter and more visually pleasing paper-like appearance than the conventional displays. In the exemplary embodiment of FIG. 2A, the high gain reflector may comprise one or more of second transparent sheet 220, convex protrusions 222, gap 232 and low refractive index medium 234 as further described below.

Second transparent sheet 220 may be located behind polarizer sheet 218 to provide support to display 200. In some embodiments, sheet 220 may be flexible or conformable. Sheet 202 may comprise glass. In some embodiments, sheet 220 may comprise glass of thickness in the range of about 20-2000 μm. In an exemplary embodiment, sheet 220 may comprise glass of thickness in the range of about 20-250 μm. Sheet 220 may comprise a flexible glass such as SCHOTT AF 32® eco or D 263® T eco ultra-thin glass. Sheet 220 may comprise a transparent polymer such as polycarbonate or an acrylic such as poly(methyl methacrylate).

Display embodiment 200 in FIG. 2A may comprise an inward array of at least one convex protrusion 222. In some embodiments, sheet 220 and protrusions 222 may be a continuous sheet (i.e., integrated) of the same material. In other embodiments, sheet 220 and protrusions 222 may be separate layers and comprised of different materials. In an exemplary embodiment, sheet 220 and protrusions 222 may comprise different refractive indices. In an exemplary embodiment, protrusions 222 may comprise a flexible polymer.

In one embodiment, protrusions 222 may comprise a high refractive index polymer. The refractive index of protrusions 222 may be greater than about 1.5. In some embodiments, convex protrusions 222 may be in the shape of hemispheres. Protrusions 222 may be of any shape or size or a mixture of shapes and sizes. Protrusions 222 may be elongated hemispheres or hexagonally shaped or a combination thereof. In other embodiments the convex protrusions may be microbeads embedded in sheet 220. Protrusions 222 may have a refractive index of about 1.5 or higher. In an exemplary embodiment, protrusions 222 may have a refractive index of about 1.5-1.9. The protrusions may have a diameter of at least about 0.5 microns. Protrusions 222 may have a diameter of at least about 2 microns. In some embodiments the protrusions may have a diameter in the range of about 0.5-5000 microns. In other embodiments, protrusions 222 may have a diameter in the range of about 0.5-500 microns. In still other embodiments, protrusions 222 may have a diameter in the range of about 0.5-100 microns. The protrusions may have a height of at least about 0.5 microns. In some embodiments the protrusions may have a height in the range of about 0.5-5000 microns. In other embodiments, protrusions 222 may have a height in the range of about 0.5-500 microns. In still other embodiments, protrusions 222 may have a height in the range of about 0.5-100 microns. In certain embodiments, protrusions 222 may include materials having a refractive index in the range of about 1.5 to 2.2. In certain other embodiments, the high refractive index protrusions may be a material having a refractive index of about 1.6 to about 1.9. Protrusions 222 may be comprised of a substantially rigid, high index material. High refractive index polymers that may be used may further comprise high refractive index additives such as metal oxides. The metal oxides may comprise one or more of SiO₂, ZrO₂, ZnO₂, ZnO or TiO₂. The refractive index of protrusions 222 may be greater than about 1.5.

In some embodiments, convex protrusions 222 may be in the shape of hemispheres as illustrated in FIG. 2A. In some embodiments the protrusions may be faceted at the base and morph into a smooth hemispherical or circular shape at the top. In other embodiments, protrusions 222 may be hemispherical or circular in one plane and elongated in another plane. In an exemplary embodiment, the convex protrusions 222 may be manufactured by micro-replication. In an exemplary embodiment, sheet 220 may be a flexible, stretchable or impact resistant material while protrusions 222 may comprise a rigid, high index material.

Display embodiment 200 in FIG. 2A may comprise a waveguide 224. Waveguide may also be referred to as a light guide. In an exemplary embodiment, waveguide 224 emits substantially uniform white light. The light may be generated by edge lighting waveguide 224 with a light source 226. In an exemplary embodiment, light source 226 may be one or more LEDs. In other embodiments, the LEDs may be narrow band LEDs configured to generate a specific color light. The LEDs may comprise narrow band red, green and blue (RGB) LEDs. The emitted light from waveguide 224 may be substantially transmitted through the respective color regions of color filter layer 210.

In one embodiment, light source 226 may provide light of a specific wavelength (or wavelengths) that is substantially spectrally matches to one or more of the optical filters used in the display. For example, if light 226 is configured to provide a red LED light, one or more optical filters may be selected to allow substantially light corresponding to red wavelength(s) to pass through.

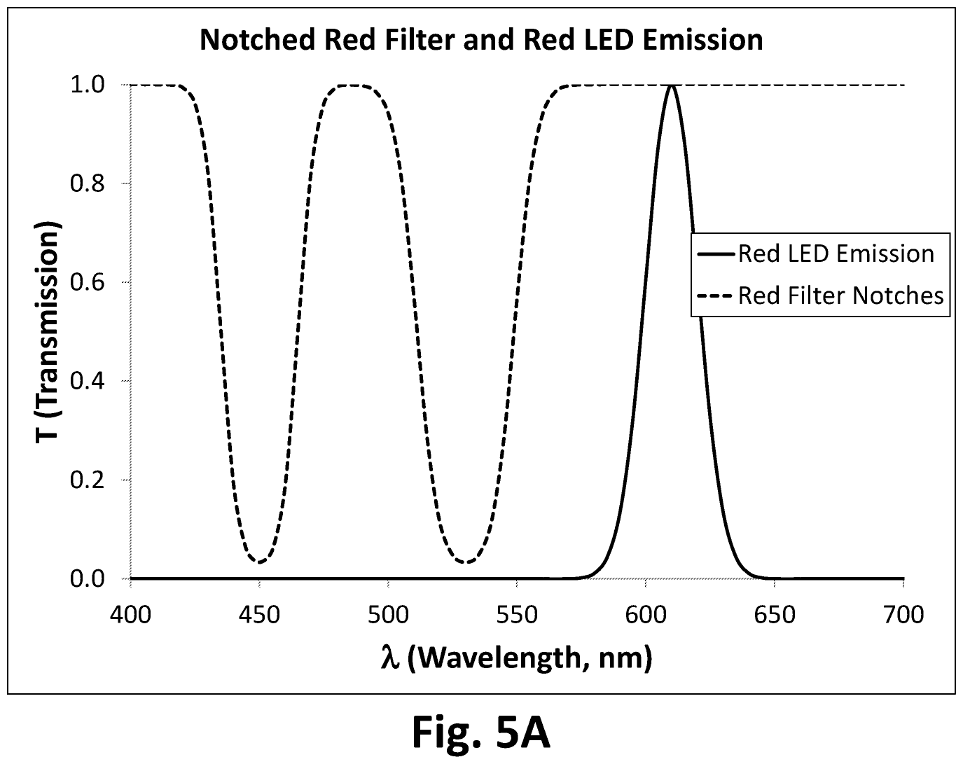

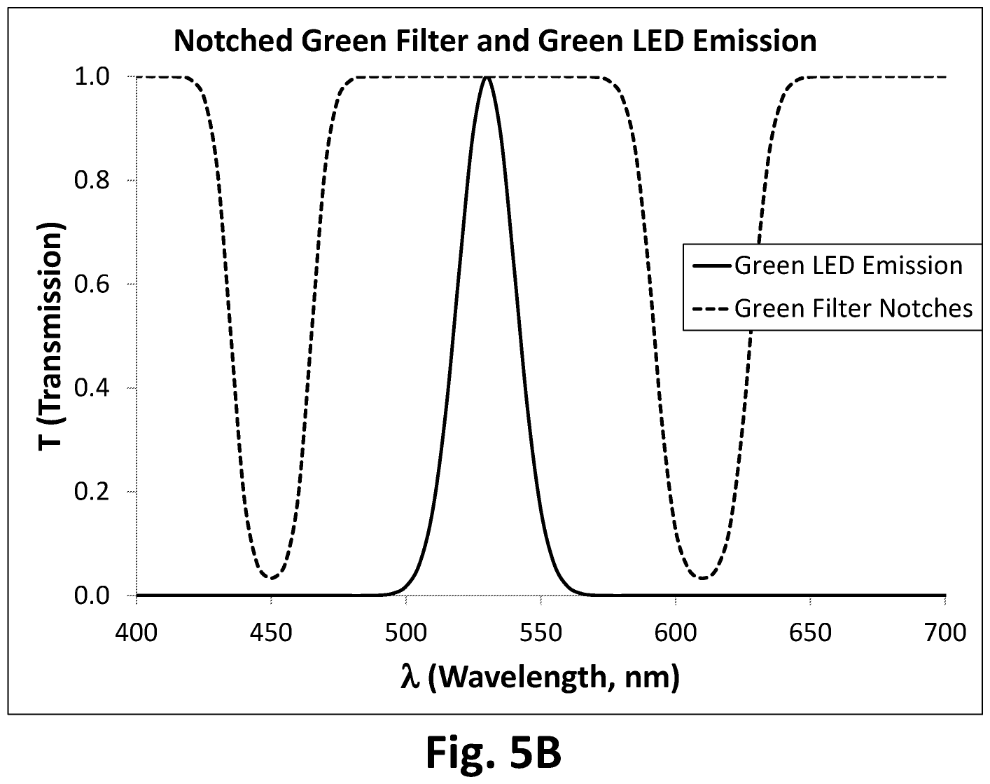

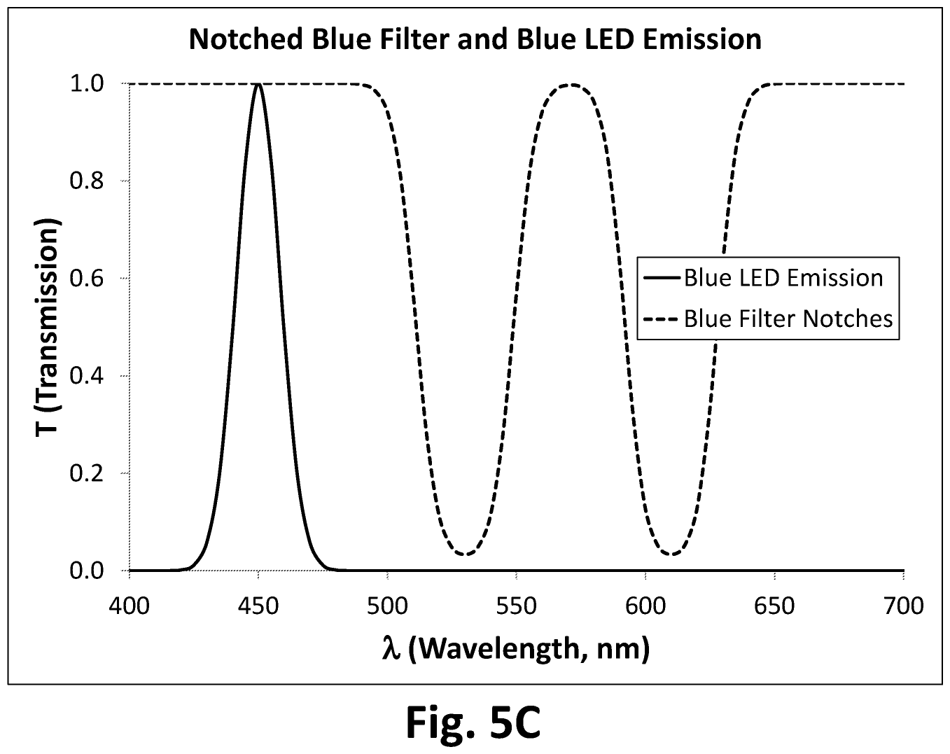

FIG. 5A graphically illustrates the spectral transmission of an embodiment of a red filter region in a notched color filter array and a red narrow wavelength emission from the waveguide. In this embodiment, light is absorbed by red color filter in layer 210 at absorption notches centered about 450 and 530 nm but is transmissive to a band of LED light from waveguide 224 centered at about 610 nm.

FIG. 5B graphically illustrates the spectral transmission of an embodiment of a green filter region in a spectrally notched absorbing color filter array and a green narrow wavelength emission from the waveguide. In this embodiment, light is absorbed by green color filter in layer 210 at absorption notches centered about 450 and 610 nm but is transmissive to a band of LED light from waveguide 224 centered at about 530 nm.

FIG. 5C graphically illustrates the spectral transmission of an embodiment of a blue filter region in a spectrally notched absorbing color filter array and a blue narrow wavelength emission from the waveguide. In this embodiment, light is absorbed by blue color filter in layer 210 at absorption notches centered about 530 and 610 nm but is transmissive to a band of LED light from waveguide 224 centered at about 450 nm.

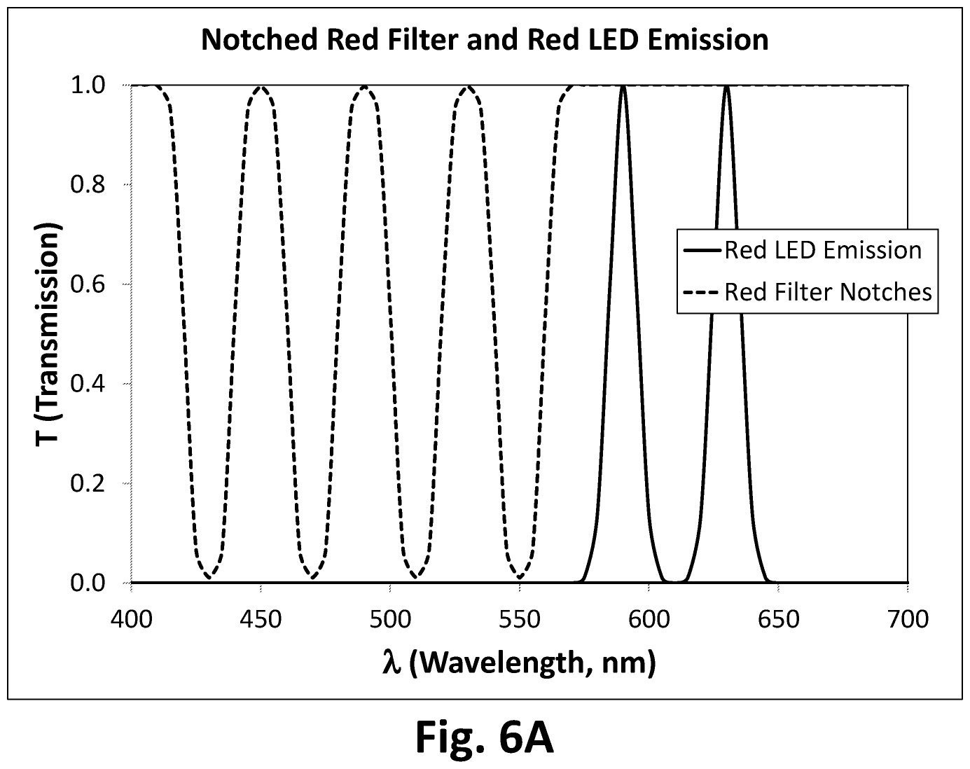

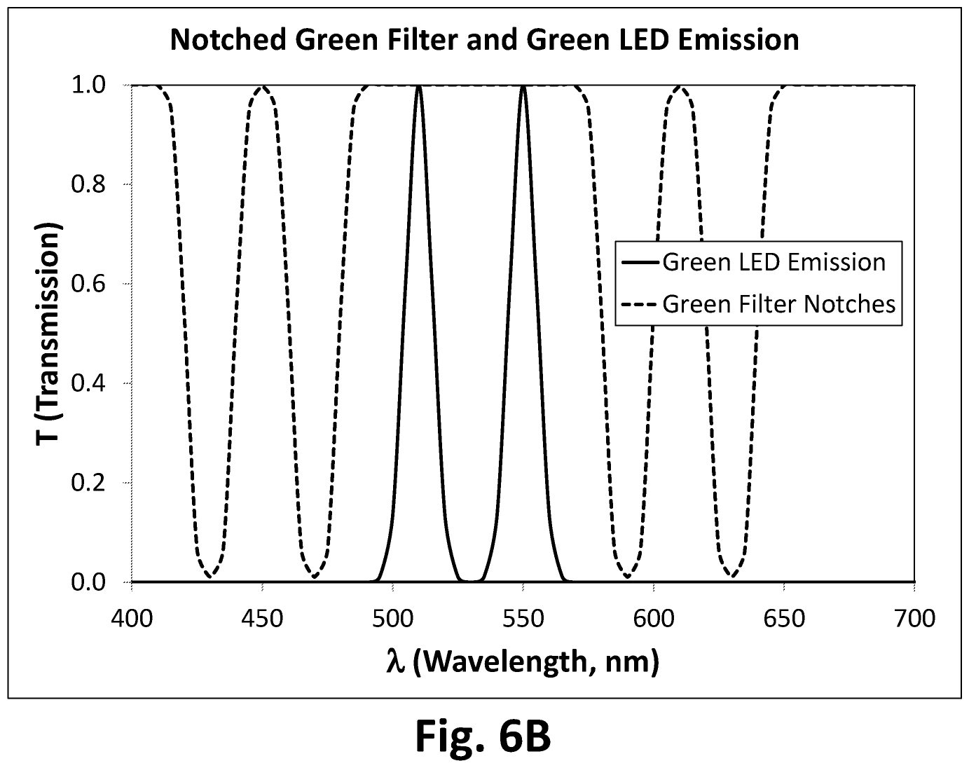

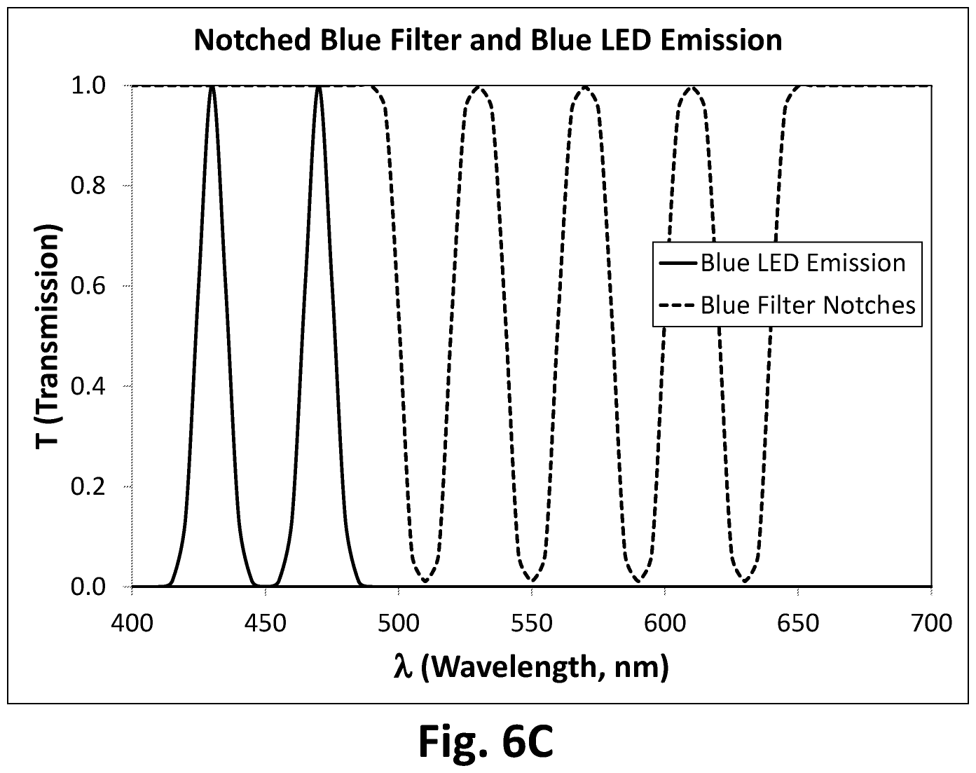

FIG. 6A graphically illustrates the spectral transmission of an embodiment of a red filter region in a spectrally notched absorbing color filter array comprising of four absorption and two emission bands from the waveguide. In this embodiment, light is absorbed by red color filter in layer 210 at absorption notches centered about 430, 470, 510 and 550 nm but is transmissive to bands of LED lights from waveguide 224 centered at about 590 and 630 nm.

FIG. 6B graphically illustrates the spectral transmission of an embodiment of a green filter region in a spectrally notched absorbing color filter array comprising of four absorption and two emission bands from the waveguide. In this embodiment, light is absorbed by green color filter in layer 210 at absorption notches centered about 430, 470, 590 and 630 nm but is transmissive to bands of LED lights from waveguide 224 centered at about 510 and 550 nm.

FIG. 6C graphically illustrates the spectral transmission of an embodiment of a blue filter region in a spectrally notched absorbing color filter array comprising of four absorption and two emission bands from the waveguide. In this embodiment, light is absorbed by blue color filter in layer 210 at absorption notches centered about 510, 550, 590 and 630 nm but is transmissive to bands of LED lights from waveguide 224 centered at about 430 and 470 nm.

The concept of using spectrally notched absorbing color filters, as graphically illustrated in FIGS. 3A-C, 4A-C, 5A-C and 6A-C, is that they appear pastel when the display is used in reflection mode. When using deep notched absorption band-based color filters according to the disclosed principles, the transmitted light rays should appear similar in brightness and color saturation to conventional broad-band color filters used in conventional reflective LCDs. The overall amount of light absorbed in conventional broad-band color filters is about the same as deep notched absorption color filters. Using notched absorption bands instead of a conventional broad band absorption allows for more light to pass through resulting in a brighter, but it provides a less color saturated display.

In contrast, when the filters are illuminated by narrow band wavelength LEDs when the display is in emissive mode as graphically illustrated in FIGS. 5A-C and 6A-C, the filters may become much more saturated. This yields an improved color gamut. Depending on illumination level, image content, and power constraints, various blends of reflection mode and illumination mode may be used. When the display is illuminated with ordinary broad band light, the filters may appear substantially pastel, because of the absence of absorption between the notches. The width of the absorption notches may determine the color saturation. Wider notches may increase saturation but overall reflectance may be lower. This may achieve a gamut of about 9% of National Television System Committee (NTSC) and filter illuminance loss of only about 37%, which is needed for reflected brightness. When the display is illuminated with the RGB LEDs, the filters may appear quite saturated. This may achieve a gamut of about 50% of NTSC, which many people desire, with a filter loss of about 57% which is acceptable for illuminated mode.

Display embodiment 200 in FIG. 2A may comprise a third light polarizing film 228. In an exemplary embodiment, film 228 is a reflective polarizing film. Film 228 may transmit perpendicular or parallel polarized light while reflecting/recycling the non-transmitted polarized light. Film 228 may comprise one or more of a polymer or glass. Film 228 may be flexible or conformable. Film 228 may be placed in the range of about 0-90° with respect to films 208, 218. Film 228 may comprise of one or more of 3M™ (Maplewood, Minn., USA) DBEF, 3M™ BEFRP, 3M™ BEF, 3M™ APF, Vikuiti™ DRPF, DuPont Teijin™ (Chester, Va., USA) ST504, ST506, ST510, STCH 11, STCH12, TCH 11, TCH 12, MELINEX® STCH22UV, STCH24UV, TCH22UV, TCH24UV, 3T Frontiers model 3105, 3205, 3205-H12, 3205-AL, 3205-N, 3205-Y or 3205-M reflective polarizer film.

Display embodiment 200 in FIG. 2A may comprise a transmitting specular reflector layer 230. In an exemplary embodiment, layer 230 may be a spectrally notched transmitting specular reflector. Layer 230 may be a RGB notch transmitting reflector. Notch transmitting specular reflector layer 230 may be highly specularly reflective to most wavelengths of light, but highly transmissive in a narrow wavelength band corresponding to the red, green and blue LEDs used in waveguide 224. Layer 230 may be a uniform film that has substantially the same optical characteristics at all points on its surface. Layer 230 may be formed from multilayer film technology. Layer 230 may be formed from many sub-wavelength thick light transmitting layers stacked in such a way that all visible wavelengths except those in select narrow wavelengths efficiently reflect, and those in the select narrow wavelength bands efficiently transmit through the layer. The RGB light emitted from waveguide 224 that transmits through reflective polarizer layer 228 (i.e. RGB light that has the desired polarization) may be efficiently transmitted through the RGB notch transmitting specular reflector layer 230 and proceed to be emitted from the top of the display stack towards viewer 206.

Layer 230 and convex protrusions 222 may form a gap or cavity 232. Gap 232 may comprise a low refractive index medium 234 in cavity 232. In an exemplary embodiment, medium 234 may comprise air. Medium 234 may be a gas such as Ar, N₂ or CO₂. Medium 234 may be a liquid. Medium 234 may be an inert, low refractive index fluid medium. Medium 234 may be a hydrocarbon. In other embodiments, the refractive index of medium 234 may be about 1 to 1.5. In still other embodiments, the refractive index of medium 234 may be about 1.1 to 1.4. In an exemplary embodiment, medium 234 may be a fluorinated hydrocarbon. In another exemplary embodiment, medium 234 may be a perfluorinated hydrocarbon. In an exemplary embodiment, medium 234 has a lower refractive index than the refractive index of convex protrusions 222. In other embodiments, medium 234 may be a mixture of a hydrocarbon and a fluorinated hydrocarbon. In an exemplary embodiment, medium 234 may comprise one or more of Fluorinert™, Novec™ 7000, Novec™ 7100, Novec™ 7300, Novec™ 7500, Novec™ 7700, Novec™ 8200, Teflon AF, CYTOP™ or Fluoropel™. In still other embodiments, medium 234 may comprise an optically clear adhesive (OCA). The gap 232 distance may be the focal length for the lens-focusing characteristic of the protrusions, in order for the light that passes through the dark pupil region to largely return in the direction from which it came. This may further enhance the semi-retro-reflective gain.

Display embodiment 200 may further comprise sidewalls 290 located in gap 232. Sidewalls 290 may help to maintain a uniform gap distance if the display is flexed or bent. Sidewalls 290 may be located in gap 232 in a periodic or random array. Sidewalls 290 may comprise polymer, glass or a metal. Sidewalls 290 may be flexible. Gap 232 may also comprise spacer units (not shown) such as beads. Spacer units may comprise a polymer.

Display embodiment 200 in FIG. 2A may further comprise a rear reflector layer 236. In an exemplary embodiment, layer 236 may be a high efficiency diffuse reflector. In other embodiments, layer 236 may be a specular reflector. Layer 236 may comprise a metal such as aluminum, silver or gold. Layer 236 may be a mirror. Layer 236 may be a metallized film comprising of a polymer film with a thin layer of metal. Layer 236 may be deposited using a physical vapor deposition process. Layer 236 may comprise one or more of polypropylene, polyethylene, polyethylene terephthalate or nylon. In an exemplary embodiment, layer 236 may comprise aluminized Mylar™. Layer 236 may comprise Teflon™. Layer 236 may be used to reflect light back towards viewer 206 for efficient light recycling.

In some embodiments, layer 236 may comprise a high efficiency diffuse light reflector. Layer 236 may be flexible or conformable. Layer 236 may comprise a polymer such as polytetrafluroethylene (PTFE). Layer 236 may comprise a Porex Corp. (Fairburn, Ga., USA) POREX® PTFE diffuser, Accuratus Corp. (Phillipsburg, N.J., USA) Accuflect® B6, Accuflect® G6, Bright View Technologies (Durham, N.C., USA) BrightWhite 98™, BrightWhite 97™ or a BrightWhite Metal diffuser.

Display embodiment 200 in FIG. 2A may further comprise a rear support layer 238. Rear support layer 238 may be flexible or conformable. Rear support layer 238 may be one or more of a metal, polymer, wood or other material. Layer 238 may one or more of glass, polycarbonate, polymethylmethacrylate (PMMA), polyurethane, acrylic, polyvinylchloride (PVC), polyimide or polyethylene terephthalate (PET). In some embodiments, layer 238 may also act as a barrier layer.

Display embodiment 200 may further comprise a voltage bias source 240. Bias source 240 that may create an electric field or electromagnetic flux across liquid crystal layer 214 situated between front electrode 212 and rear electrode 216. The flux may change the orientation of the liquid crystals in layer 214. In an exemplary embodiment, twisted nematic liquid crystals located in layer 214 may re-orient by application of a bias. Twisted nematic liquid crystals in layer 214 may return to an original state upon removal of an applied voltage bias.

Bias source 240 may be coupled to one or more processor circuitry and memory circuitry configured to change or switch the applied bias in a predefined manner and/or for predetermined durations. For example, the processing circuitry may switch the applied bias to display characters on display 200.

FIG. 2A schematically illustrates a cross-section of an embodiment of a hybrid reflective-emissive LC-high gain reflector display in a bright state in the reflective mode of operation. Two modes of reflection to create an enhanced bright state relative to conventional LCD displays will be illustrated in embodiment 200. It should be noted that these modes are representative only. Many other modes of reflection may be possible. In a first illustrative mode of reflection, light 242 may enter display embodiment 200 and pass through a first polarizing layer 208. Polarizing layer 208 absorbs a portion of the incident light. It is assumed, for illustrative purposes only, that the polarizer layer 208 absorbs perpendicular polarized light only and allows all parallel polarized light to approach layer 214 comprising of liquid crystals. It is assumed that layer 214 comprises twisted nematic liquid crystals. The twisted nematic liquid crystals are in their natural twisted state as it is assumed that no power is being applied to the front 210 and rear electrodes 214. As the parallel polarized light enters layer 214, the twisted nematic liquid crystals interact with and convert the light from parallel to perpendicular polarized light. The perpendicular polarized light is allowed to pass through absorptive polarizing layer 218 that lies at about a 90° angle to polarizing layer 208. This allows light to continue to pass through reflective polarizing layer 218 towards array of convex protrusions 222. Some light is allowed to directly pass through array 222 as light enters at an angle such that it does not undergo total internal reflection (TIR) at the interface of high refractive index layer 222 and low refractive index medium 234. Light that is incident upon the interface at angles less than critical angle, θ_{c}, may be transmitted through the interface. Light that is incident upon the interface at angles greater than θ_{c} may undergo TIR at the interface. A small critical angle (e.g., less than about 50°) may be preferred at the TIR interface since this affords a large range of angles over which TIR may occur. In some embodiments, it may be desirable to have medium 234 with preferably as small a refractive index (η₃) as possible and to have protrusions 222 composed of a material having a refractive index (η₁) preferably as large as possible. The critical angle, θ_{c}, is calculated by the following equation (Eq. 1):

$${θ}_{c} = {sin}^{- 1} ( \frac{{η}_{3}}{{η}_{1}} ) \qquad ( 1 )$$

In the example of FIG. 2A, light passes through the “dark pupil” region at an angle less than θ_{c}. The light may then be reflected by notch transmitting specular reflecting layer 230 back towards viewer 206. The perpendicular polarized light passes through polarizer layers 218 towards layer 214 comprising twisted nematic liquid crystals. Light may then be converted back to parallel polarized light such that it may pass back through front polarizing layer 208 towards viewer 206 to appear as a bright state. This is represented by incident light 242 and reflected light 244. Some light may also pass through layer 230 and be reflected by diffuse reflector layer 236. This light may not exit until it attains the correct polarization to pass through layer 228. This light may be recycled until it attains the correct polarization.

In another example mode of reflection as illustrated in FIG. 2A, representative light 246 may enter a pixel in display 200 and first polarizer layer 208 where perpendicular polarized light may be absorbed and parallel polarized light may continue to enter the display. The parallel polarized light 246 may be converted to perpendicular polarized light by interaction with the nematic liquid crystals in layer 214. The perpendicular polarized light may pass through light polarizing layer 218 towards the interface of array of high refractive index protrusions 222 and low refractive index medium 234. In this location, light 240 arrives at the interface at an angle larger than critical angle, θ_{c}. Light 240 may then be totally internally reflected back towards viewer 206 as representative light 248 that retains its perpendicular polarization. The perpendicular polarized light may then pass through polarizing layer 218 towards liquid crystal layer 214. Liquid crystal layer 214 comprising twisted nematic liquid crystals interacts with light 248 and converts it to parallel polarized light such that it may pass through front polarizing layer 208. Light 248 may then exit display 200 towards viewer 206 such that the pixel appears bright to viewer 206.

In the reflective mode described in FIG. 2A, display embodiment 200 should reflect light efficiently under bright ambient lighting conditions (such as outdoors on a sunny day). Notched color filter array 210 may provide an unsaturated display but with acceptable color quality. For the reflective light, the wavelength bands of the ambient light that transmits through color array layer 210 may be efficiently reflected by the specular reflective nature of notched specular reflector layer 230. The color saturation may be as good as any LCD reflective display and the image quality may be greatly enhanced because the diffuse, semi-retroreflective TIR-based reflector layer 222 may result in a bright, white, paper-like appearance. The power consumption in this mode may be very low because the backlight is turned off.

FIG. 2B schematically illustrates a cross-section of an embodiment of a hybrid reflective-emissive LC-high gain reflector display in a dark state in a reflective mode of operation. Light 250, 252 may enter display embodiment 200 and pass through a first polarizing layer 208. Polarizing layer 208 absorbs a portion of the incident light. It is assumed, for illustrative purposes only, that the polarizer layer 208 absorbs perpendicular polarized light only and allows all parallel polarized light to approach layer 214 comprising of liquid crystals. Liquid crystals in layer 214 may be reoriented to allow light to pass through layer 214 without changing the polarization. This may be carried out by applying a voltage bias to layer 214 by voltage source 240. The parallel polarized light 250, 252 may be absorbed by absorptive polarizing layer 218 that lies at about a 90° angle to first polarizing layer 208. This creates a dark state in display 200 in the reflective mode.

Voltages of various levels may be applied across layer 214 in order to re-orient the liquid crystals to varying degrees. This varies the amount of light that may be absorbed by or pass through layer 218. Gray states may be formed by partial reorientation of the liquid crystals in layer 214. Some light may thus be absorbed by layer 218 while some light may be reflected by the high gain reflective unit comprising layers 222, 230.

FIG. 2C schematically illustrates a cross-section of an embodiment of a hybrid reflective-emissive LC-high gain reflector display in a bright state in the emissive mode of operation. The emissive mode of operation may be utilized by display embodiment 200 when there may not be sufficient ambient light present to operate satisfactorily in reflective mode. Several emissive/reflective modes are described in FIG. 2C that are illustrative only. Many other emissive/reflective modes may be possible.

In a first mode, waveguide 224 may emit light 260 that is generated by edge lighting with LEDs. The LEDs may be narrow band RGB LEDs as previously described herein and graphically illustrated in FIGS. 5A-C, 6A-C. In this first illustrative mode, light 260 has the correct polarization to completely pass through reflective polarizer layer 228. It may then pass through rear absorptive polarization layer 218 but some light will be lost due to absorption of the parallel or polarized light. In this example it will be assumed that perpendicular light is absorbed and parallel light is allowed to pass through. The parallel light 260 may then pass through LC layer 214 where it may be converted to perpendicular light 260 to pass through front absorptive polarizer layer 208 towards viewer 206. The display appears bright and emissive to viewer 206.

In a second illustrative emissive mode, light 262 may be emitted by waveguide 224. Light 262 may have incorrect polarization to pass through reflective polarizer layer 228. Light 262 then be reflected back as reflected light 264 towards rear specular reflector layer 236. Light 262, 264 may be recycled until it attains the correct polarization to pass through reflective polarizer layer 228. This is represented by emitted light 266 as it passes through display embodiment 200 towards viewer 206. Light 266 may similarly pass through display 200 as previously described for exiting light 260.

In a third illustrative emissive mode, light 268 may be emitted by waveguide 224. A portion of light 268 may have the correct polarization to pass through layer 228 and be emitted from display 200 as light 270 towards viewer 206. Another portion of light 268 that does not have the correct polarization may be reflected by layer 228 as light 272 (dotted line). Light 272 may be recycled between rear specular reflector layer 236 and layer 228 until it achieves the correct polarization. When it achieves the correct polarization it may be emitted from display 200 towards viewer 206. This is represented by emitted light 274 (dotted line). It should be reiterated that the three emissive/reflective modes described herein are for illustrative purposes only. Many other emissive/reflective modes may be possible. Furthermore, display 200 in emissive mode may be bright color saturated. This is due to the RGB LEDs are matched to the transmission notches in color filter array 210. The power consumption in this mode may be as good as a conventional emissive display because the light may be efficiently in the high efficiency backlit waveguide.

FIG. 2D schematically illustrates a cross-section of an embodiment of a hybrid reflective-emissive LC-high gain reflector display in a dark state in the emissive mode of operation. Light 280, 282 may be emitted from waveguide 224 towards viewer 206 (Some light may also be emitted toward layer 236 where it may then be reflected towards viewer 206). As light 280, 282 enters the rear absorptive polarizing layer 218, some of the light is absorbed. For illustrative purposes, the parallel light may be absorbed and the perpendicular light is allowed to further pass through display 200. As perpendicular light enters LC layer 214, the liquid crystals are oriented by application of a voltage bias from source 240 such that the LC layer does not convert the perpendicular light into parallel light. As a result, perpendicular light 280, 282 may be absorbed by front polarizing layer 208 that is arranged at about a 90° angle to rear polarizing layer 218. This prevents light 280, 282 from exiting display 200 towards viewer 206. Thus, the display appears dark to viewer 206. The modulation of bright and dark states in display 200 may be completed on a pixel-by-pixel basis to generate images and display information.

Display embodiment 200 in FIGS. 2A-D may be operated in a combination of reflective and emissive modes based on availability of ambient light. Hybrid mode may be operated in ambient lighting conditions such as in a typical illuminated indoor environment or outdoors on a cloudy day or in shade. For the reflective light, the wavelengths bands of the ambient light that transmits through color array layer 210 may be efficiently reflected by the specular reflective nature of notched specular reflector layer 230. The only wavelengths of light that would not be efficiently reflected by notched specular reflector layer 230 would have already been absorbed by color filter layer 210, so no further light may be lost upon reflection from layer 230. Similarly for the emitted light, the RGB LEDs in the backlight have been selected to match with the notched transmission characteristics of color array layer 210, so the emitted light may efficiently be transmitted through this layer. The resulting hybrid reflective/emissive image may be very bright and have saturated color with wide gamut. The saturation and gamut of the color image may be controlled via the display software. The compatibility and synergy of the reflective and emissive modes may be a result of the careful design of all of the components in the stack.

In an exemplary embodiment, display 200 may further comprise an ambient light sensor. When ambient light is high above a pre-determined level, display 200 may operate in reflection mode. When ambient light is low and below a pre-determined level, display 200 may operate in emissive mode. When ambient light is present in a range of levels, display 200 may operate in a hybrid mode. In one embodiment, the ambient light sensor is positioned in the periphery of the hybrid display.

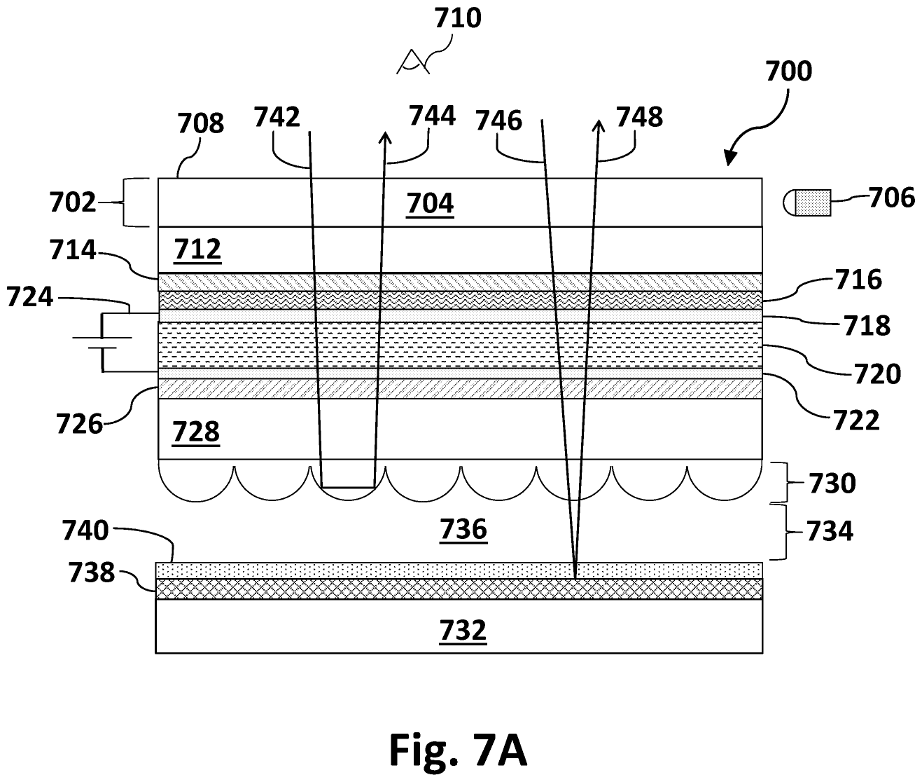

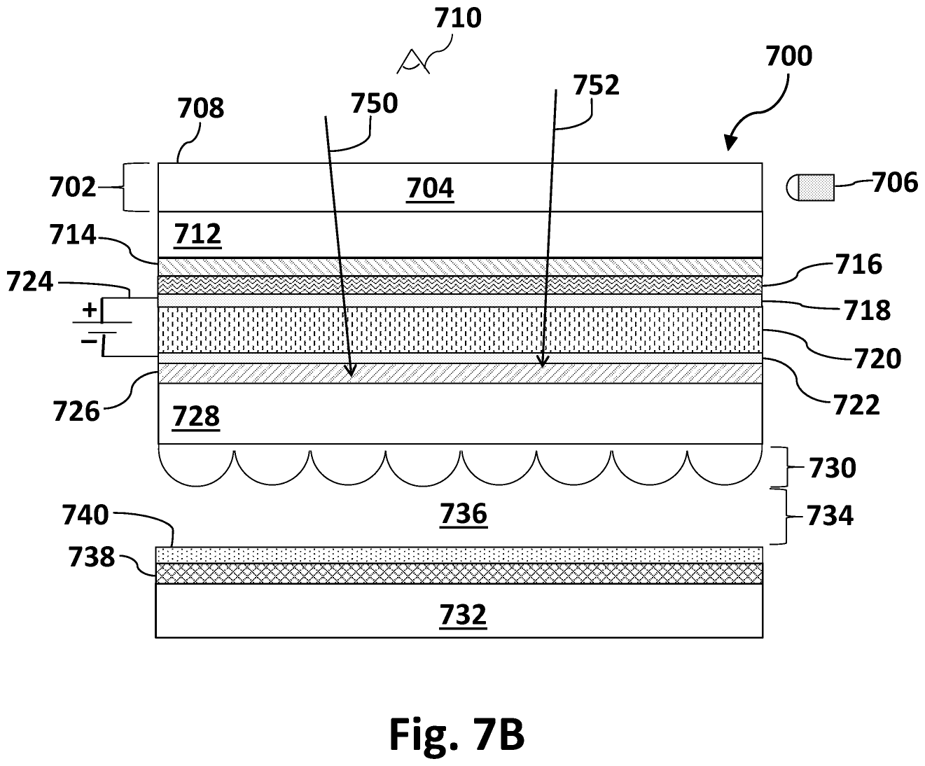

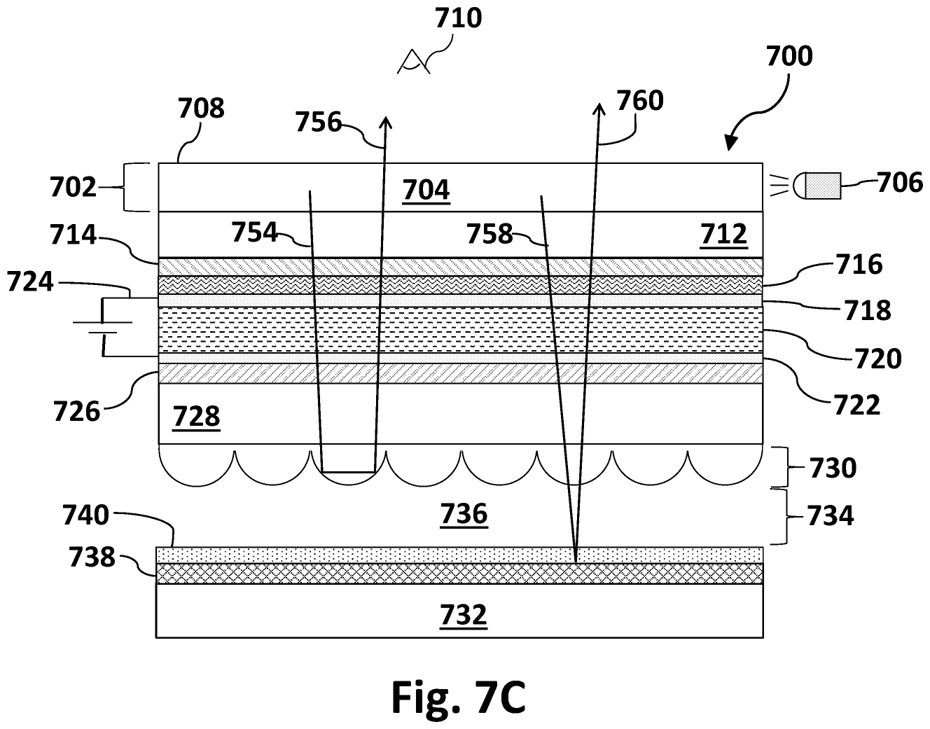

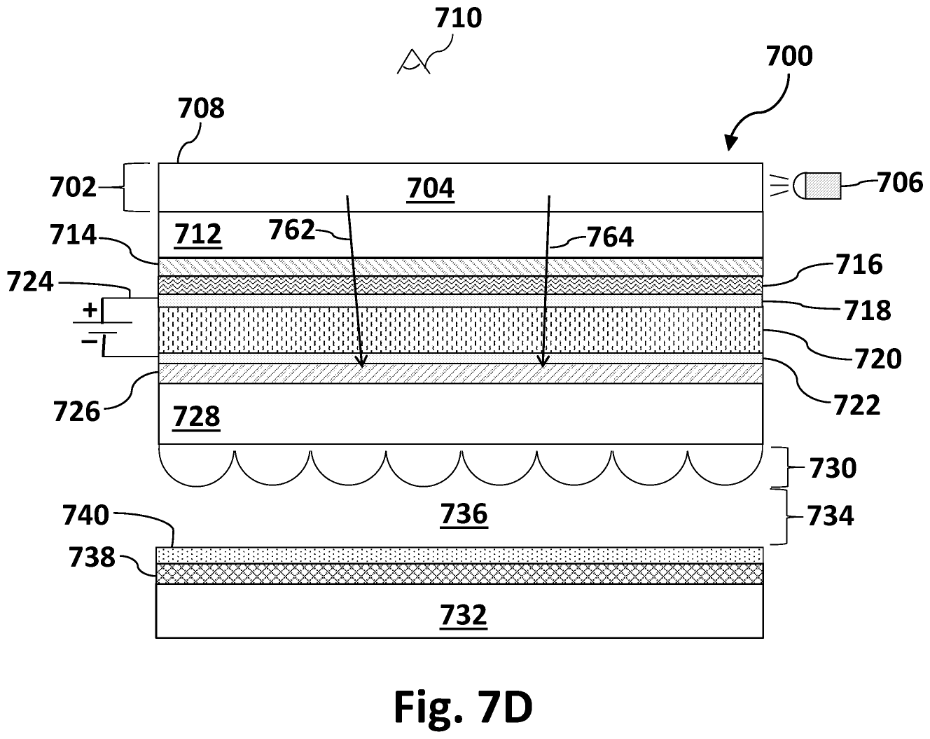

FIG. 7A schematically illustrates a cross-section of an embodiment of a hybrid reflective-emissive LC-high gain reflector display with a front light in a bright state in the reflective mode of operation. Hybrid display embodiment 700 in FIG. 7A is similar to displays illustrated in FIGS. 2A-D and described herein but with some modifications. Display 700 may comprise a directional front light system 702. Front light system 702 may comprise a waveguide 704 and light source 706. Front light system 702 comprises an outer surface 708 facing viewer 710. In an exemplary embodiment, light source 706 may comprise narrow band LEDs.

Display 700 in FIG. 7A may further comprise an optional transparent front support sheet 712 which may also perform as a barrier layer. Display embodiment 700 may further comprise a first light polarizer layer 714, a deep notched absorption color filter layer 716, front electrode 718 layer, liquid crystal layer 720, rear electrode layer 722 and voltage bias source 724 capable of forming a bias between electrodes 718, 722 and across layer 720. Display 700 may further comprise a second light polarizer layer 726, optional rear transparent support 728 and rear high refractive index convex protrusion array layer 730. Display embodiment 700 may further comprise a rear support 732 that form a gap 734 with convex protrusion array layer 730. Gap 734 may contain a low refractive index medium 736 such as air or a liquid.

As in FIGS. 2A-2D, a high gain reflector may be optionally incorporated into display 700 of FIG. 7. The high gain reflector may comprise one or more of rear transparent support 728, high refractive index protrusion array 730, gap 734 and low refractive index medium 736.

Display embodiment 700 may further comprise a high efficiency diffuse reflector 738 and reflective polarizer layer 740. In other embodiments, one or both of layers 738 and 740 may be replaced with a specular reflector layer.

Two modes of reflection will be illustrated in embodiment 700 in FIG. 7A. It should be noted that these modes are representative only. Many other modes of reflection may be possible.

In a first illustrative mode of reflection, light 742 may enter display embodiment 700 and pass through a first polarizing layer 714. Polarizing layer 714 absorbs a portion of the incident light. It is assumed, for illustrative purposes only, that the polarizer layer 714 absorbs perpendicular polarized light only and allows all parallel polarized light to approach layer 720 comprising of liquid crystals. It is assumed that layer 720 comprises twisted nematic liquid crystals. The twisted nematic liquid crystals are in their natural twisted state as it is assumed that no power is being applied to the front 718 and rear electrodes 722. As the parallel polarized light enters layer 720, the twisted nematic liquid crystals interact with and convert the light from parallel to perpendicular polarized light. The perpendicular polarized light is allowed to pass through absorptive polarizing layer 726 that lies at about a 90° angle to polarizing layer 714. This allows light to continue to pass through polarizing layer 726 towards array of convex protrusions 730. Some light undergoes TIR at the interface of high refractive index layer 730 and low refractive index medium 736 as previously explained herein. The totally internally reflected light 742 is reflected back towards viewer 710 as reflected light ray 744.

In the second illustrative mode, representative light 746 enters a pixel in display 700 and first polarizer layer 714 where perpendicular polarized light may be absorbed and parallel polarized light may continue to enter the display. The parallel polarized light 746 may be converted to perpendicular polarized light by interaction with the nematic liquid crystals in layer 720. The perpendicular polarized light may pass through light polarizing layer 726 towards the interface of array of high refractive index protrusions 730 and low refractive index medium 736. In this location, light 746 arrives at the interface at an angle smaller than critical angle, θ_{c}, and passes through the “dark pupil” region as previously explained. Light 746 may then be totally internally reflected back towards viewer 710 by high efficiency diffuse reflector layer 738 as representative light 748. If reflected light 748 retains the proper polarization after reflection from layer 738 it may pass through reflective polarizer layer 740 and exit the display back towards viewer 710. In some instances, the polarization of incident light 746 may change after reflection off of diffuse reflector layer 738. In these instances, reflective polarizer layer 740 may reflect the light back towards layer 738 until the light has the correct polarization to pass through layer 740. Light may thus be recycled between layer 738 and layer 740 until the proper polarization is attained so that the light may exit the display.

FIG. 7B schematically illustrates a cross-section of an embodiment of a hybrid reflective-emissive LC-high gain reflector display with a front light in a dark state in the reflective mode of operation. Light 748, 750 may enter display embodiment 700 and pass through a first polarizing layer 714. Polarizing layer 714 absorbs a portion of the incident light. It is assumed, for illustrative purposes only, that the polarizer layer 714 absorbs perpendicular polarized light only and allows all parallel polarized light to approach layer 720 comprising of liquid crystals. Liquid crystals in layer 720 may be reoriented to allow light to pass through layer 720 without changing the polarization. This may be carried out by applying a voltage bias across layer 720 by voltage source 724. The parallel polarized light 750, 752 may be absorbed by absorptive polarizing layer 726 that lies at about a 90° angle to first polarizing layer 714. This creates a dark state in display 700 in the reflective mode.

FIG. 7C schematically illustrates a cross-section of an embodiment of a hybrid reflective-emissive LC-high gain reflector display with a front light in a bright state in the emissive mode of operation. The emissive mode of operation may be utilized by display embodiment 700 when there may not be sufficient ambient light present to operate satisfactorily in reflective mode. Two emissive/reflective modes are illustrated in FIG. 7C. Many other emissive/reflective modes may be possible. In a first mode, waveguide 704 may emit light 754 that is generated by edge lighting with LEDs. The LEDs may be narrow band RGB LEDs as previously described herein and graphically illustrated in FIGS. 5A-C, 6A-C. Light 754 may pass through polarizer layer 714 but some light will be lost due to absorption of the parallel or polarized light. In this example it will be assumed that perpendicular light is absorbed and parallel light is allowed to pass through. The parallel light 754 may then pass through notched color filter layer 716 and LC layer 720 where it may be converted to perpendicular light to pass through rear absorptive polarizer layer 726 towards layer of convex protrusions 730. Light 754 may then be totally internally reflected at the interface of high refractive layer 730 and low refractive medium 736. The reflected light may then exit the display as reflected light 756. The display appears bright and emissive to viewer 710.

A second emissive/reflective mode illustrated in FIG. 7C by light 758. Light 758 emitted from waveguide 704 may pass through front polarizer layer 714, color filter layer 716, LC layer 720 and rear polarizer layer 726 as previously described herein. Light that passes through the dark pupil region in layer 730 may then be reflected by a high efficiency diffuse reflector 738. If light 758 retains the correct polarization in may pass through reflective polarizer 740 and exit the display. In some instances, the polarization may be incorrect and it is reflected back towards layer 738 by layer 740. The light may be recycled until it retains the correct polarization. Once the correct polarization is attained it may pass through layer 740 and the rest of the display as reflected light ray 760. The display appears bright and emissive to viewer 710.

In another embodiment, layers 738 and 740 may be replaced by a specular reflector. Specular reflectors typically reflect light and do not substantially change the polarization allowing the light to be emitted from the display. A specular reflector layer may be used in placed of layers 738 and 740 in FIGS. 7A-D.

FIG. 7D schematically illustrates a cross-section of an embodiment of a hybrid reflective-emissive LC-high gain reflector display with a front light in a dark state in the emissive mode of operation. Light 762, 764 may be emitted by waveguide 704, enter display 700 and pass through a first polarizing layer 714. Polarizing layer 714 absorbs a portion of the incident light. It is assumed, for illustrative purposes only, that the polarizer layer 714 absorbs perpendicular polarized light only and allows parallel polarized light to pass through and approach layer 720 comprising of liquid crystals. Liquid crystals in layer 720 may be reoriented to allow light to pass through layer 720 without changing the polarization. This may be carried out by applying a voltage bias across layer 720 by voltage source 724. The parallel polarized light 762, 764 may be absorbed by rear absorptive polarizing layer 726 that lies at about a 90° angle to first polarizing layer 714. This creates a dark state in display 700 in the emissive mode. This may be carried out on a pixel by pixel basis in the display.

Display embodiment 700 in FIGS. 7A-D may be operated in a combination of reflective and emissive modes based on availability of ambient light. Hybrid mode may be operated in ambient lighting conditions such as in a typical illuminated indoor environment or outdoors on a cloudy day or in shade. The hybrid reflective/emissive image may be very bright and have saturated color with wide gamut. The saturation and gamut of the color image may be controlled via the display software. The compatibility and synergy of the reflective and emissive modes may be a result of the careful design of all of the components in the stack.

In an exemplary embodiment, display 700 may further comprise an ambient light sensor. When ambient light is high above a pre-determined level, display 700 may operate in reflection mode. When ambient light is low and below a pre-determined level, display 700 may operate in emissive mode. When ambient light is present in a range of levels, display 700 may operate in a hybrid mode.

It should be known that matching spectrally notched absorbing color filters with narrow band emissive LEDs, as described herein, may be combined with other reflective display technologies to enhance brightness. This technology may be combined with electrowetting displays (i.e. Liquivista B.V., Eindhoven, the Netherlands), electrofluidic displays, microencapsulated electrophoretic displays (i.e. E Ink Holdings, Hsinchu, Taiwan; OED Technologies, Guangzhou, China), reflective LCDs, microelectromechanical-based systems (MEMs) or other reflective display systems. This technology may be used as front lighting or backlighting systems.

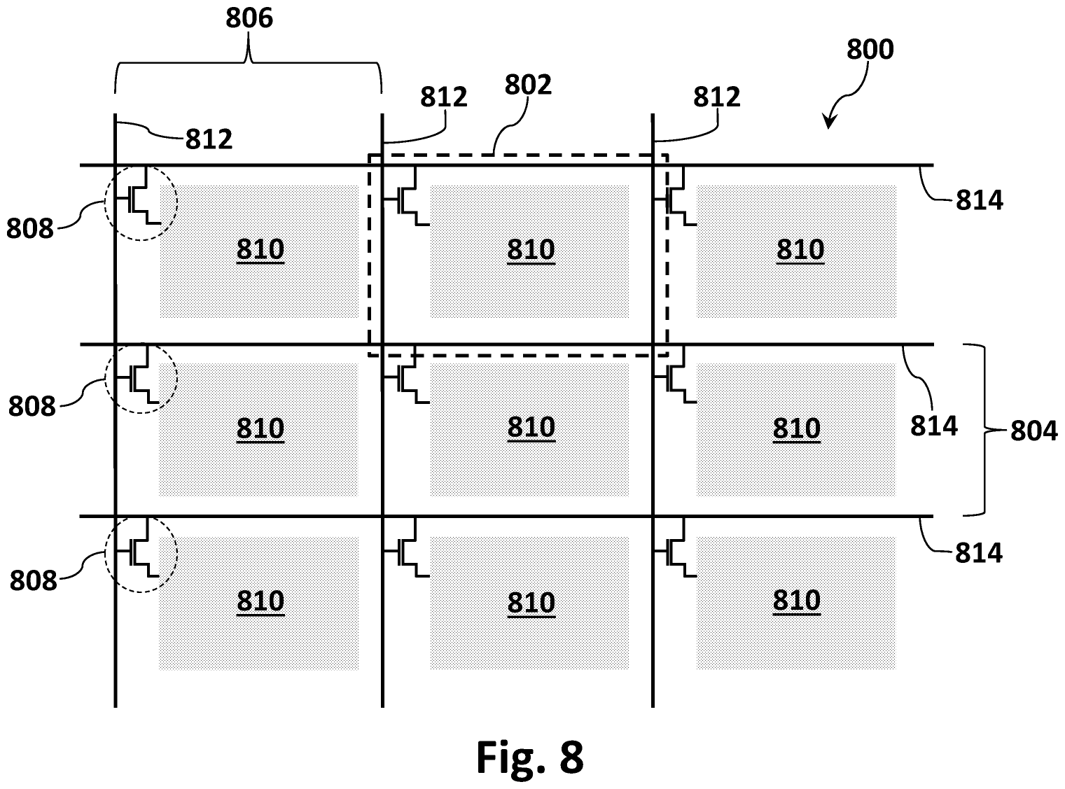

FIG. 8 schematically illustrates an embodiment of a TFT array to drive a display. The TFT array is similar to the arrays used to drive conventional LCD displays. The arrangement of liquid crystals in layer 214 in FIGS. 2A-D and liquid crystals in layer 720 in FIGS. 7A-D may be controlled TFT array embodiment 800 in FIG. 8. In an exemplary embodiment, TFT array 800 may be used as the top electrode layer 212 in FIGS. 2A-D and layer 718 in FIGS. 7A-D. In other embodiments, TFT array 800 may be used as the bottom electrode layer 216 in FIGS. 2A-D and layer 722 in FIGS. 7A-D. TFT array 800 may comprise an array of pixels 802 to drive the display embodiments described herein. A single pixel 802 is highlighted by a dotted line box in FIG. 8. Pixels 802 may be arranged in rows 804 and columns 806 as illustrated in FIG. 8 but other arrangements may be possible. In an exemplary embodiment, each pixel 802 may comprise a single TFT 808. In array embodiment 800, each TFT 808 may be located in the upper left of each pixel 802. In other embodiments, the TFT 808 may be placed in other locations within each pixel 802. Each pixel 802 may further comprise a conductive layer 810 to address each pixel of the display. Layer 810 may comprise ITO, aluminum, copper, gold, Baytron™, or conductive nanoparticles, silver wires, metal nanowires, graphene, nanotubes, or other conductive carbon allotropes or a combination of these materials dispersed in a polymer. TFT array embodiment 800 may further comprise column 812 and row 814 wires. Column wires 812 and row wires 814 may comprise a metal such as aluminum, copper, gold or other electrically conductive metal. Column 812 and row 814 wires may comprise ITO. The column 812 and row 814 wires may be attached to the TFTs 808. Pixels 802 may be addressed in rows and columns. TFTs 808 may be formed using amorphous silicon or polycrystalline silicon. The silicon layer for TFTs 808 may be deposited using plasma-enhanced chemical vapor deposition (PECVD). In an exemplary embodiment, each pixel may be substantially aligned with a single color filter in layer 210, 716. Column 812 and row 814 wires may be further connected to integrated circuits and drive electronics to drive the display.

Any of the disclosed embodiments may comprise a diffuser layer. A diffuser layer may be used to soften the incoming light or reflected light or to reduce glare. Diffuser layer may comprise a flexible polymer. Diffuser layer may comprise ground glass in a flexible polymer matrix. Diffuser may comprise a micro-structured or textured polymer. Diffuser layer may comprise 3M™ anti-sparkle or anti-glare film. Diffuser layer may comprise 3M™ GLR320 film (Maplewood, Minn.) or AGF6200 film. A diffuser layer may be located at one or more various locations within the display embodiments described herein.

Any of the disclosed embodiments may further comprise at least one optically clear adhesive (OCA) layer. OCA layer may be flexible or conformable. OCA's may be used to adhere display layers together and to optically couple the layers. Any of the display embodiments described herein may comprise optically clear adhesive layers further comprised of one or more of 3M™ optically clear adhesives 3M™ 8211, 3M™ 8212, 3M™ 8213, 3M™ 8214, 3M™ 8215, 3M™ OCA 8146-X, 3M™ OCA 817X, 3M™ OCA 821X, 3M™ OCA 9483, 3M™ OCA 826XN or 3M™ OCA 8148-X, 3M™ CEF05XX, 3M™ CEF06XXN, 3M™ CEF19XX, 3M™ CEF28XX, 3M™ CEF29XX, 3M™ CEF30XX, 3M™ CEF31, 3M™ CEF71XX, Lintec MO-T020RW, Lintec MO-3015UV series, Lintec MO-T015, Lintec MO-3014UV2+, Lintec MO-3015UV.

Any of the disclosed embodiments may further include at least one optional dielectric layer. The one or more optional dielectric layers may be used to protect one or both of the layers in any of the display embodiments described herein. In some embodiments, the dielectric layers may comprise different compositions. The dielectric layers may be substantially uniform, continuous and substantially free of surface defects.

The dielectric layers may be at least about 5 nm in thickness or more. In some embodiments, the dielectric layer thickness may be about 5 to 300 nm. In other embodiments, the dielectric layer thickness may be about 5 to 200 nm. In still other embodiments, the dielectric layer thickness may be about 5 to 100 nm. The dielectric layers may each have a thickness of at least about 30 nanometers. In an exemplary embodiment, the thickness may be about 30-200 nanometers.

In other embodiments, parylene may have a thickness of about 20 nanometers. The dielectric layers may comprise at least one pin hole. The dielectric layer may define a conformal coating and may be free of pin holes or may have minimal pin holes. The dielectric layer may also be a structured layer. The dielectric layer may also act as a barrier layer to prevent moisture or gas ingress. The dielectric layers may have a high or low dielectric constant. The dielectric layers may have a dielectric constant in the range of about 1-15. Dielectric compounds may be organic or inorganic in type. The most common inorganic dielectric material is SiO₂ commonly used in integrated chips. The dielectric layer may be SiN. The dielectric layer may be Al₂O₃. The dielectric layer may be a ceramic. Organic dielectric materials are typically polymers such as polyimides, fluoropolymers, polynorbornenes and hydrocarbon-based polymers lacking polar groups. The dielectric layers may be a polymer or a combination of polymers. The dielectric layers may be combinations of polymers, metal oxides and ceramics. In an exemplary embodiment, the dielectric layers comprise parylene. In other embodiments the dielectric layers may comprise a halogenated parylene. Other inorganic or organic dielectric materials or combinations thereof may also be used for the dielectric layers. One or more of the dielectric layers may be CVD or sputter coated. One or more of dielectric layers may be a solution coated polymer, vapor deposited dielectric or sputter deposited dielectric.

Any of the display embodiments described herein may further comprise a conductive cross-over. A conductive cross-over may bond to the front electrode layer and to a trace on the rear electrode layer such as a TFT. This may allow a driver integrated circuit (IC) to control the voltage at the front electrode. In an exemplary embodiment, the conductive cross-over may comprise an electrically conductive adhesive that is flexible or conformable.

In order to bend or flex any of the display embodiments described herein comprising convex protrusions, the protrusions may be spaced far enough apart such that they do not impinge on neighboring protrusions. As the amount of flex is desired in the display increases, the spacing may need to be increased to prevent impinging of adjacent protrusions. The smaller the spacing, the less the display may be allowed to flex or bend. In some embodiments the spacing between the protrusions may be about 0.01 μm or larger. In other embodiments, the spacing between the protrusions may be about 0.01-10 μm. In still other embodiments, the spacing between the protrusions may be about 1-5 μm. In some embodiments, the ratio of the height of a protrusion to the spacing of adjacent protrusions is in the range of about 100:1 to about 5:1.

At least one edge seal may be employed with the disclosed display embodiments. The edge seal may prevent ingress of moisture or other environmental contaminants from entering the display. The edge seal may be a thermally, chemically or a radiation cured material or a combination thereof. The edge seal may comprise one or more of an epoxy, silicone, polyisobutylene, acrylate or other polymer based material. In some embodiments the edge seal may comprise a metallized foil. In some embodiments the edge sealant may comprise a filler such as SiO₂ or Al₂O₃. In other embodiments, the edge seal may be flexible or conformable after curing. In still other embodiments, the edge seal may also act as a barrier to moisture, oxygen and other gasses.

At least one sidewall (may also be referred to as cross-walls or partition walls) may be employed with the disclosed display embodiments. In an exemplary embodiment, sidewalls may substantially maintain a uniform gap distance within specified areas of the display embodiments. Sidewalls may also act as a barrier to aid in preventing prevent moisture and oxygen ingress into the display. The sidewalls may be located within the light modulation layer comprising the liquid crystals, electrowetting solution or other materials. The sidewalls may comprise polymer, metal or glass or a combination thereof. The sidewalls may be any size or shape. The sidewalls may have a rounded cross-section. The sidewalls or cross-walls may be configured to create wells or compartments in, for example, square-like, triangular, pentagonal or hexagonal shapes or a combination thereof. The sidewalls may comprise a polymeric material and patterned by one or more conventional techniques including photolithography, embossing or molding. In an exemplary embodiment, the sidewalls may be comprised of a flexible or conformal polymer.

Various control mechanisms for the invention may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

In some embodiments, a tangible machine-readable non-transitory storage medium that contains instructions may be used in combination with the disclosed display embodiments. In other embodiments the tangible machine-readable non-transitory storage medium may be further used in combination with one or more processors.

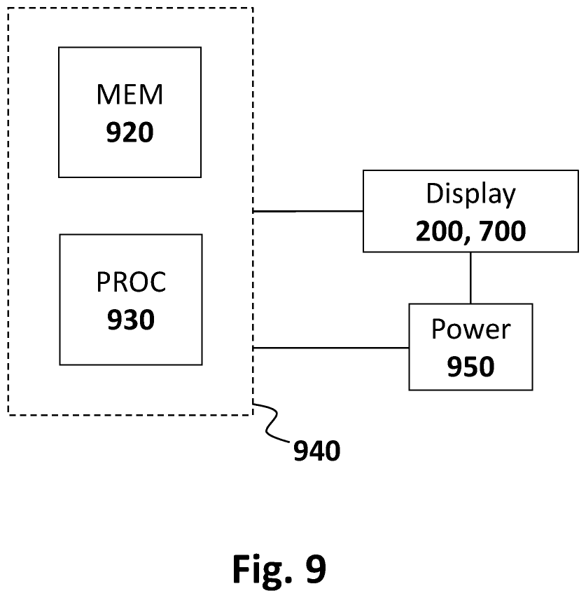

FIG. 9 shows an exemplary system for controlling a display according to one embodiment of the disclosure. In FIG. 9, display 200, 700 is controlled by controller 940 having processor 930 and memory 920. Other control mechanisms and/or devices may be included in controller 940 without departing from the disclosed principles. Controller 940 may define hardware, software or a combination of hardware and software. For example, controller 940 may define a processor programmed with instructions (e.g., firmware). Processor 930 may be an actual processor or a virtual processor. Similarly, memory 920 may be an actual memory (i.e., hardware) or virtual memory (i.e., software).

Memory 920 may store instructions to be executed by processor 930 for driving display 200, 700. The instructions may be configured to operate display 200, 700. In one embodiment, the instructions may include biasing electrodes associated with display 200, 700 through power supply 950. When biased, the electrodes may cause movement of electrophoretic particles towards or away from a region proximal to the surface of the plurality of protrusions at the inward surface of the front transparent sheet to thereby absorb or reflect light received at the inward surface of the front transparent sheet. By appropriately biasing the electrodes, liquid crystals (e.g., liquid crystals 214 in FIGS. 2A-D; liquid crystals 720 in FIGS. 7A-D) may be controlled such as the orienting or reorienting of twisted nematic liquid crystals. Absorbing the incoming light creates a dark or colored state. By appropriately biasing the electrodes, liquid crystals (e.g., liquid crystals 214 in FIGS. 2A-D; liquid crystals 720 in FIGS. 7A-D) may be controlled such as the twisting or untwisting of twisted nematic liquid crystals in order to reflect or absorb the incoming light. Reflecting the incoming light creates a light state.

In the exemplary display embodiments described herein, they may be used in Internet of Things (IoT) devices. The IoT devices may comprise a local wireless or wired communication interface to establish a local wireless or wired communication link with one or more IoT hubs or client devices. The IoT devices may further comprise a secure communication channel with an IoT service over the internet using a local wireless or wired communication link. The IoT devices comprising one or more of the display devices described herein may further comprise a sensor. Sensors may include one or more of a temperature, humidity, light, sound, motion, vibration, proximity, gas or heat sensor. The IoT devices comprising one or more of the display devices described herein may be interfaced with home appliances such as a refrigerator, freezer, television (TV), close captioned TV (CCTV), stereo system, heating, ventilation, air conditioning (HVAC) system, robotic vacuum, air purifiers, lighting system, washing machine, drying machine, oven, fire alarms, home security system, pool equipment, dehumidifier or dishwashing machine. The IoT devices comprising one or more of the display devices described herein may be interfaced with health monitoring systems such as heart monitoring, diabetic monitoring, temperature monitoring, biochip transponders or pedometer. The IoT devices comprising one or more of the display devices described herein may be interfaced with transportation monitoring systems such as those in an automobile, motorcycle, bicycle, scooter, marine vehicle, bus or airplane.

In the exemplary display embodiments described herein, they may be used IoT and non-IoT applications such as in, but not limited to, electronic book readers, portable computers, tablet computers, cellular telephones, smart cards, signs, watches, wearables, military display applications, automotive displays, automotive license plates, shelf labels, flash drives and outdoor billboards or outdoor signs comprising a display. The displays may be powered by one or more of a battery, solar cell, wind, electrical generator, electrical outlet, AC power, DC power or other means.

The following exemplary embodiments are provided to further illustrate the disclosed principles. These examples are illustrative and non-limiting.

Example 1 is directed to a liquid crystal display pixel, comprising: a first polarizer to receive a first light ray having a first polarization state and a second polarization state, the first polarizer configured to substantially remove the first polarization state from the first light ray to form a first wavelengths polarized light ray; an optical color filter configured to receive the first polarized light ray and to allow substantial transmission of a first optical frequency band of the first polarized light ray through the color filter to form a first filtered light ray; a liquid crystal layer; a high gain reflector having a first and a second medium arranged to form an interface therebetween, the interface configured to totally internally reflect the first filtered light ray when the first filtered light ray is incident on the interface at an angle that is greater than the critical angle (θc); and a light source to emit a second light ray to the high gain reflector.

Example 2 is directed to display pixel of example 1, wherein the light source and the optical color filter are spectrally matched.

Example 3 is directed to the display pixel of example 1, wherein the light source provides a second light ray having a second bandwidth and wherein the optical color filter is configured to substantially pass light of the second bandwidth while substantially filtering light outside of the second bandwidth.

Example 4 is directed to the display pixel of example 1, wherein the optical color filter comprises a notch filter and wherein the notch filter is configured to allow substantial transmission of one or more frequency bands matching one of red, green or blue color wavelengths.

Example 5 is directed to the display pixel of example 1, further comprising a second polarizer configured to substantially remove the second polarization state of the first light ray.

Example 6 is directed to the display pixel of example 1, wherein the high gain reflector is configured to allow the first filtered light ray to pass therethrough when the first filtered light ray is incident on the interface at an angle less than a critical angle (θc).

Example 7 is directed to the display pixel of example 1, further comprising a light guide layer to receive the second light ray from the light source and to transmit the received second light ray to the high gain reflector.

Example 8 is directed to the display pixel of example 7, further comprising a rear light polarizing layer and a rear reflector layer positioned to interpose the light guide layer.

Example 9 is directed to the display pixel of example 8, wherein the at least one of the front or the rear reflector comprises a spectrally notched reflector.

Example 10 is directed to the display of example 1, wherein the first light ray comprises ambient light and has a first bandwidth.

Example 11 is directed to a liquid crystal display, comprising: a first polarizer to receive a plurality of ambient light rays, the plurality of ambient light rays having a first polarization state and a second polarization state, the first polarizer configured to substantially remove the first polarization state from the plurality of ambient light rays to form a plurality of polarized ambient light rays; a first optical filter having a first optical bandpass, the first optical filter configured to receive and spectrally filter a first portion of the plurality of polarized ambient light rays to provide a first filtered ray; a second optical filter having a second bandpass, the second optical filter configured to receive and spectrally filter a second portion of the plurality of polarized ambient light rays to provide a second filtered ray; a liquid crystal layer to receive the first filtered ray and the second filtered ray; a high gain reflector having a first and a second medium arranged to form an interface therebetween, the interface configured to totally internally reflect one of the first filtered ray and the second filtered ray when the rays of the first optical band is incident on the interface at an angle that is greater than the critical angle (θc); a first light source to emit light of a first spectral band; and a second light source to emit light of a second spectral band.

Example 12 is directed to the display of example 11, wherein the first light source and the first optical color filter are spectrally matched and wherein the second light source and the second optical filter are spectrally matched.

Example 13 is directed to the display of example 11, wherein the first optical color filter comprises a spectrally notched color filter and wherein the spectrally notched color filter is configured to allow substantial transmission of one or more frequency bands matching one of red, green or blue color wavelengths.

Example 14 is directed to the display of example 11, further comprising a second polarizer to substantially remove the second polarization state of the plurality of ambient light rays.

Example 15 is directed to the display of example 11, wherein the high gain reflector is configured to allow the first filtered ray and the second filtered ray to pass therethrough when the first filtered light ray is incident on the interface at an angle less than a critical angle (θc).

Example 16 is directed to the display of example 11, further comprising a light guide layer to receive an incoming ray from the first light source and to transmit the incoming ray to the high gain reflector.

Example 17 is directed to the display of example 16, further comprising a front reflector and a rear reflector positioned to interpose the light guide layer.

Example 18 is directed to the display of example 17, wherein the at least one of the front or the rear reflector comprises a spectrally notched reflector.

Example 19 is directed to a method to display spectrally matched rays, the method comprising: substantially removing a first polarization state from an incoming ambient light ray at an optical polarizer to form an ambient polarized light ray; receiving and spectrally filtering the ambient polarized light ray at an optical filter to provide a filtered ambient light ray, the optical filter having a spectral bandpass; receiving the filtered ambient light ray at a high gain reflector having an interface; totally-internally reflecting the received filtered ambient light ray when the light ray enters the interface at an angle equal or greater than a critical angle (θc); and passing the filtered ambient light ray through the high gain reflector when the filtered ambient light ray is incident on the interface at an angle less than the critical angle (θc); receiving an emitted light ray from a light source.

Example 20 is directed to the method of example 19, wherein the emitted light ray has a spectral bandwidth substantially similar to the optical filter spectral bandwidth.

Example 21 is directed to the method of example 19, further comprising directing the received emitted light ray to the optical polarizer through the high gain reflector.

Example 22 is directed to the method of example 19, wherein the light source and the optical color filter are spectrally matched.

Example 23 is directed to the method of example 19, wherein spectrally filtering the ambient polarized light further comprises filtering the ambient polarized light through a spectrally notched color filter and substantially transmitting a frequency band matching one of red, green or blue color wavelengths through the notch filter.

Example 24 is directed to the method of example 19, further comprising substantially removing a second polarization state from the incoming ambient light ray to form a second ambient polarized light ray.

Example 25 is directed to the method of example 19, further comprising directing the emitted light from the light source to a viewer through a waveguide.

Example 26 is directed to the method of example 25, wherein directing the emitted light through the waveguide further comprises transmitting the emitted light from the waveguide layer through a specular reflector layer.

While the principles of the disclosure have been illustrated in relation to the exemplary embodiments shown herein, the principles of the disclosure are not limited thereto and include any modification, variation or permutation thereof.

1. A liquid crystal display pixel, comprising:
a first polarizer to receive a first light ray having a first polarization state and a second polarization state, the first polarizer configured to substantially remove the first polarization state from the first light ray to form a first wavelengths polarized light ray;
an optical color filter configured to receive the first polarized light ray and to allow substantial transmission of a first optical frequency band of the first polarized light ray through the color filter to form a first filtered light ray;
a liquid crystal layer;
a high gain reflector having a first and a second medium arranged to form an interface therebetween, the interface configured to totally internally reflect the first filtered light ray when the first filtered light ray is incident on the interface at an angle that is greater than the critical angle (θc); and
a light source to emit a second light ray to the high gain reflector.

2. The display pixel of claim 1, wherein the light source and the optical color filter are spectrally matched.

3. The display pixel of claim 1, wherein the light source provides a second light ray having a second bandwidth and wherein the optical color filter is configured to substantially pass light of the second bandwidth while substantially filtering light outside of the second bandwidth.

4. The display pixel of claim 1, wherein the optical color filter comprises a notch filter and wherein the notch filter is configured to allow substantial transmission of one or more frequency bands matching one of red, green or blue color wavelengths.

5. The display pixel of claim 1, further comprising a second polarizer configured to substantially remove the second polarization state of the first light ray.

6. The display pixel of claim 1, wherein the high gain reflector is configured to allow the first filtered light ray to pass therethrough when the first filtered light ray is incident on the interface at an angle less than a critical angle (θc).

7. The display pixel of claim 1, further comprising a light guide layer to receive the second light ray from the light source and to transmit the received second light ray to the high gain reflector.

8. The display pixel of claim 7, further comprising a rear light polarizing layer and a rear reflector layer positioned to interpose the light guide layer.

9. The display pixel of claim 8, wherein the at least one of the front or the rear reflector comprises a spectrally notched reflector.

10. (canceled)

11. A liquid crystal display, comprising:
a first polarizer to receive a plurality of ambient light rays, the plurality of ambient light rays having a first polarization state and a second polarization state, the first polarizer configured to substantially remove the first polarization state from the plurality of ambient light rays to form a plurality of polarized ambient light rays;
a first optical filter having a first optical bandpass, the first optical filter configured to receive and spectrally filter a first portion of the plurality of polarized ambient light rays to provide a first filtered ray;
a second optical filter having a second bandpass, the second optical filter configured to receive and spectrally filter a second portion of the plurality of polarized ambient light rays to provide a second filtered ray;
a liquid crystal layer to receive the first filtered ray and the second filtered ray;
a high gain reflector having a first and a second medium arranged to form an interface therebetween, the interface configured to totally internally reflect one of the first filtered ray and the second filtered ray when the rays of the first optical band is incident on the interface at an angle that is greater than the critical angle (θc);
a first light source to emit light of a first spectral band; and
a second light source to emit light of a second spectral band.

12. The display of claim 11, wherein the first light source and the first optical color filter are spectrally matched and wherein the second light source and the second optical filter are spectrally matched.

13. The display of claim 11, wherein the first optical color filter comprises a spectrally notched color filter and wherein the spectrally notched color filter is configured to allow substantial transmission of one or more frequency bands matching one of red, green or blue color wavelengths.

14. The display of claim 11, further comprising a second polarizer to substantially remove the second polarization state of the plurality of ambient light rays.

15. The display of claim 11, wherein the high gain reflector is configured to allow the first filtered ray and the second filtered ray to pass therethrough when the first filtered light ray is incident on the interface at an angle less than a critical angle (θc).

16. The display of claim 11, further comprising a light guide layer to receive an incoming ray from the first light source and to transmit the incoming ray to the high gain reflector.

17. The display of claim 16, further comprising a front reflector and a rear reflector positioned to interpose the light guide layer.

18. The display of claim 17, wherein the at least one of the front or the rear reflector comprises a spectrally notched reflector.

19. A method to display spectrally matched rays, the method comprising:
substantially removing a first polarization state from an incoming ambient light ray at an optical polarizer to form an ambient polarized light ray;
receiving and spectrally filtering the ambient polarized light ray at an optical filter to provide a filtered ambient light ray, the optical filter having a spectral bandpass;
receiving the filtered ambient light ray at a high gain reflector having an interface;
totally-internally reflecting the received filtered ambient light ray when the light ray enters the interface at an angle equal or greater than a critical angle (θc); and
passing the filtered ambient light ray through the high gain reflector when the filtered ambient light ray is incident on the interface at an angle less than the critical angle (θc);
receiving an emitted light ray from a light source.

20. The method of claim 19, wherein the emitted light ray has a spectral bandwidth substantially similar to the optical filter spectral bandwidth.

21. The method of claim 19, further comprising directing the received emitted light ray to the optical polarizer through the high gain reflector.

22. (canceled)

23. The method of claim 19, wherein spectrally filtering the ambient polarized light further comprises filtering the ambient polarized light through a spectrally notched color filter and substantially transmitting a frequency band matching one of red, green or blue color wavelengths through the notch filter.

24. The method of claim 19, further comprising substantially removing a second polarization state from the incoming ambient light ray to form a second ambient polarized light ray.

25. The method of claim 19, further comprising directing the emitted light from the light source to a viewer through a waveguide.

26. The method of claim 25, wherein directing the emitted light through the waveguide further comprises transmitting the emitted light from the waveguide layer through a specular reflector layer.
